(19) United States
(12) Patent Application Publication
(10) Pub. No.: US 2005/0021984 A1
(43) Pub. Date: Jan. 27, 2005

(54) Encryption system

(75) Inventor: Harry Hollander, Broadbeach (AU)

Correspondence Address: DARBY & DARBY P.C., P. O. BOX 5257, NEW YORK, NY, 10150-5257, US

(73) Assignee: Thumbaccess Biometrics Corporation Pty Ltd., North Sydney (AU)

(21) Appl. No.: 10/859,617

(22) Filed: Jun. 1, 2004

Related U.S. Application Data
(63) Continuation of application No. PCT/AU02/01592, filed on Nov. 29, 2002.

(51) Int. Cl. H04L 9/32

(52) U.S. Cl. 713/186

(57) ABSTRACT

The present invention provides a method of allowing a sender to encrypt a data object for transfer to a recipient via a communication system. The method includes determining biometric data representative of at least one of the sender and the recipient. The determined biometric data is used to generate an encryption key which is used to encrypt the data object. The encrypted data object is then transferred to the recipient via the communications system.

### BACKGROUND OF THE INVENTION

The present invention relates to a method and apparatus for allowing data objects to be encrypted and then decrypted to allow secure transfer via communications system. In particular, the method uses biometric data in the encryption process.

### DESCRIPTION OF THE PRIOR ART

The reference to any prior art in this specification is not, and should not be taken as, an acknowledgement or any form of suggestion that the prior art forms part of the common general knowledge.

The growth in electronic commerce and communication is increasing dramatically every year. E-mail in particular has become a popular form of communication for business, governments and private citizens. However the security of e-mail is questionable, with potential interception by company computer administrator sanctioned by many organisations. It has been documented in a number of instances where other non-authorised people within a company have been able to intercept colleagues e-mail traffic. It is also known that the Internet Service Provider (ISP) to an organisation could potentially monitor and intercept e-mail transmissions. Recently the FBI has revealed that it has been able to track e-mail communications from various suspected terrorists.

Thus it is plainly obvious that although very convenient and widely accepted as a legitimate form of communication, e-mail in its current form is not secure.

A further complicating factor is that although e-mail is used for communication between a sender and a recipient, the legitimacy of such contact is open to challenge. Thus, for example, it is possible for a third party to fraudulently masquerade as a legitimate sender by sending e-mails using the senders e-mail address.

Accordingly, there is a need for a secure form of transmitting data via communications networks, and in particular public networks, such as the Internet.

### SUMMARY OF THE PRESENT INVENTION

In a first broad form the present invention provides a method of allowing a sender to encrypt a data object for transfer to a recipient via a communication system, the method including:
a) Determining biometric data representative of at least one of the sender and the recipient;
b) Using the determined biometric data to generate an encryption key;
c) Encrypting the data object using the generated encryption key and a predetermined encryption algorithm; and,
d) Transferring the encrypted data object to the recipient via the communications system.

The method usually includes generating biometric data by:
a) Generating a scanned image by scanning a portion of the user; and,
b) Generating the biometric data representative of the user from the scanned image.

The method of generating the biometric data from the scanned image usually includes applying a predetermined one-way function to the scanned image.

The method may include generating the encryption key using the generated biometric data representative of the sender.

Alternatively, the method includes:
a) Validating the identity of the sender; and,
b) Generating the encryption key in response to a successful validation.

In this case, the method of validating the sender typically includes:
a) Comparing the generated biometric data representative of the sender to predetermined biometric data representative of the sender; and,
b) Validating the sender in response to a successful comparison.

The validation is usually performed by a processor coupled to a data store, the data store being adapted to store the sender's predetermined biometric data, the processor being adapted to:
a) Receive an indication of the sender;
b) Receive the sender's generated biometric data;
c) Obtain the predetermined biometric data from the data store in accordance with the indication of the sender;
d) Compare the sender's generated biometric data and the predetermined biometric data; and,
e) Validate the sender in response to a successful comparison.

The processor and the data store are generally located at a base station. In this case, the method typically includes using an end station to transfer the data object to the recipient via the communications system.

The end station would typically include:
a) An input;
b) A scanning system;
c) A communications link, for coupling the end station to the communications system; and,
d) An end station processor, the method generally including causing the end station processor to:
   i) Receive an input command from the sender requesting the transfer of the data object;
   ii) Determine sender's biometric data by causing the scanning system to scan a portion of the sender;
   iii) Generate the encryption key;
   iv) Encrypt the data object with the determined encryption key; and,
   v) Transfer the data object to the communications system.

The encryption key is preferably based on the biometric data of both the recipient and the sender.

The method typically further includes:
a) Causing the end station processor to transfer to the base station:
   i) The sender's biometric data;
   ii) An indication of the recipient; and,
   iii) An indication of the sender;
b) Causing the base station processor to:
   i) Validate the sender; and,
   ii) In response to a successful validation:
      (1) Obtain the biometric data of the recipient from a database in accordance with the received indication;
      (2) Transfer the recipient's biometric data to the end station.

The database may be the data store, although other databases may be used depending on the circumstances.

The method may include causing the end station processor to transfer to the sender's biometric data to the base station by:
a) Encrypting the sender's biometric data; and,
b) Transferring the sender's encrypted biometric data to the base station, the base station processor being adapted to decrypt the received encrypted biometric data.

In this case, the biometric data can be encrypted using a second predetermined encryption algorithm and a second encryption key, the second encryption key being generated by a remote processing system, the method including:
a) Causing the end station processor to:
   i) Obtain the second encryption key from the remote processing system; and,
   ii) Encrypt the sender's biometric data using the second encryption algorithm and the obtained second encryption key;
b) Causing the base station processor to decrypt the encrypted sender biometric data by:
   i) Obtaining the second encryption key from the remote processing system; and,
   ii) Decrypting the sender's encrypted biometric data using the second encryption algorithm and the obtained second encryption key.

Typically, the method of obtaining the second encryption key from the remote processing system includes:
a) Generating a request for an encryption key;
b) Transferring the request to the remote processing system;
c) Causing the remote processing system to:
   i) Generate the second key;
   ii) Encrypt the second encryption key;
   iii) Transfer the encrypted second encryption key via a secure connection;
d) Receiving the encrypted second encryption key via the secure connection; and,
e) Decrypt the second encryption key.

The secure connection is usually a 128-bit SSL connection, although other connections could be used.

Similarly, the method can include causing the base station processor to transfer to the recipient's biometric data to the base station by:
a) Encrypting the recipient's biometric data; and,
b) Transferring the encrypted biometric data to the end station, the end station processor being adapted to decrypt the received encrypted biometric data.

Again, in this case, the biometric data can be encrypted using a third predetermined encryption algorithm and a third encryption key, the third encryption key being generated by a remote processing system, the method including:
a) Causing the base station processor to:
   i) Obtain the third encryption key from the remote processing system; and,
   ii) Encrypt the biometric data using the third encryption algorithm and the obtained third encryption key;
b) Causing the end station processor to decrypt the encrypted biometric data by:
   i) Obtaining the third encryption key from the remote processing system; and,
   ii) Decrypting the recipient's encrypted biometric data using the third encryption algorithm and the obtained third encryption key.

Thus again, the method of obtaining the third encryption key from the remote processing system typically includes:
a) Generating a request for an encryption key;
b) Transferring the request to the remote processing system;
c) Causing the remote processing system to:
   i) Generate the third key;
   ii) Encrypt the third encryption key;
   iii) Transfer the encrypted third encryption key via a secure connection;
d) Receiving the encrypted third encryption key via the secure connection; and,
e) Decrypt the third encryption key.

It will be appreciated that the second and third encryption algorithms and keys are preferably identical.

The data object may be any data object, such as a data file, or the like, but is preferably an e-mail, which may or may not include an attachment. However, the data object may be any form of data file that be transmitted via communications networks, such as the Internet. Thus, the data objects could include electronic faxes, media files, and the like.

In this case, the indications of he recipient and/or sender can be e-mail addresses.

Preferably, the biometric data is formed from by scanning the user's thumb or finger, although other unique identifiers, such as retina prints, and the like, can be used.

In a second broad form the present invention provides an end station for allowing a sender to encrypt a data object for transfer to a recipient via a communication system, the end station including:
a) An input;
b) A communications link, for coupling the end station to the communications system; and,
c) An end station processor, adapted to:
   i) Receive an input command from the sender requesting the transfer of the data object;
   ii) Determine an encryption key based on biometric data representative of at least one of the sender and the recipient;
   iii) Encrypt the data object with the encryption key; and,
   iv) Transfer the data object to the communications system.

The end station generally also includes a scanning system, the scanning system being adapted to determine the sender's biometric data by scanning a portion of the sender.

In a third broad form the present invention provides a base station for allowing a sender to encrypt a data object for transfer to a recipient via a communication system, the base station including:
a) A data store for storing biometric data;
b) A processor, the processor being adapted to validate the sender to allow the data object to be encrypted by:
   i) Receiving an indication of the sender;
   ii) Receiving the sender's generated biometric data;
   iii) Obtaining predetermined biometric data from the data store in accordance with an indication of the sender;
   iv) Comparing the sender's biometric data and the predetermined biometric data; and,
   v) Validating the sender in response to a successful comparison.

In a fourth broad form the present invention provides apparatus for allowing a sender to encrypt a data object for transfer to a recipient via a communication system, the apparatus including a processor adapted to:
a) Determine biometric data representative of at least one of the sender and the recipient;
b) Use the determined biometric data to generate an encryption key;
c) Encrypt the data object using the generated encryption key and a predetermined encryption algorithm; and,
d) Transfer the encrypted data object to the recipient via the communications system.

In this case, the apparatus is typically adapted to perform the method of the first broad form of the invention.

The apparatus usually also includes an end station according to the second broad form of the invention, and a base station according to the third broad form of the invention.

In a fifth broad form the present invention provides a method of allowing a recipient to decrypt an encrypted data object received from a sender via a communication system, the method including:
a) Receiving the encrypted data object from the communications system;
b) Determining biometric data representative of at least one of the sender and the recipient;
c) Using the determined biometric data to generate a decryption key; and,
d) Decrypting the encrypted data object using the generated decryption key and a predetermined decryption algorithm.

It will be appreciated therefore that this uses a similar method to the first broad form of the present invention.

Accordingly, similarly a sixth, seventh and eighth broad forms of the invention provide an end station, a base station and apparatus for allowing a recipient to decrypt an encrypted data object received from a sender via a communication system.

It will also be appreciated that the present invention may also provide computer program products including computer executable code for causing suitably programmed processing systems to perform the method of the first and fifth broad forms of the invention.

In a ninth broad form the present invention provides a method of securely transferring a data object from a first end station to a second end station via a communication system, the method including:
a) Causing the first end station to request an encryption key from a remote processing system coupled to the communications system;
b) Causing the remote processing system to transfer the requested encryption key to the first end station;
c) Causing the first end station to:
   i) Encrypt the data object with the received encryption key;
   ii) Transfer the encrypted data object to the second end station;
d) Causing the second end station to request a decryption key from the remote processing system;
e) Causing the remote processing system to transfer the requested decryption key to the second end station;
f) Causing the second end station to decrypt the data object with the received decryption key.

Typically the encryption and decryption keys are identical, although this is not necessarily the case.

Typically the method further of transferring the encryption/decryption key includes causing the processing system to encrypt the encryption/decryption key before transferring the encryption/decryption key to the first/second end station.

Typically the method further of transferring the encryption/decryption key includes transferring the encryption/decryption key to the first/second end station via a secure connection.

In this case, the secure connection may for example be a 128-bit SSL connection.

In a tenth broad form the present invention provides a system for securely transferring a data object from a first end station to a second end station via a communication system, the system including a processing system adapted to:
a) Generate an encryption key in response to a request from the first end station;
b) Transfer the requested encryption key to the first end station, the first end station being adapted to:
   i) Encrypt the data object with the received encryption key;
   ii) Transfer the encrypted data object to the second end station;
c) Generate a decryption key in response to a request from the second end station;
d) Transfer the requested decryption key to the second end station, the second end station being adapted to decrypt the data object with the received decryption key.

Accordingly, the system is generally adapted to operate in accordance with the method of the ninth broad form of the invention.

The present invention also typically provides a computer program product, the computer program product including computer executable code which when operated by a suitable processing system causes the processing system to operate in accordance with the ninth or tenth aspect of the invention.

### BRIEF DESCRIPTION OF THE DRAWINGS

An example of the present invention will now be described with reference to the accompanying drawings, in which:

FIG. 1 is a schematic diagram of an example of a system for implementing the present invention;

FIG. 2 is a schematic diagram of an example of one of the processing system of FIG. 1;

FIG. 3 is a schematic diagram of an example of one of the end stations of FIG. 1;

FIG. 4 is a flow chart of a registration process implemented by the system of FIG. 1;

FIG. 5A and 5B are a flow chart of an example of an encryption process implemented by the system of FIG. 1;

FIG. 6A and 6B are a flow chart of an example of a decryption process implemented by the system of FIG. 1;

FIG. 7 is a flow chart of an example of a process for determining e-mail addresses implemented by the system of FIG. 1; and,

FIG. 8 is a schematic diagram showing the flow of data for securely transferring data between the end stations and the base stations of FIG. 1;

FIGS. 9A, 9B and 9C are a flow chart of an example of a chat process implemented by the system of FIG. 1;

FIGS. 10A and 10B are examples of screen shots for the chat process of FIGS. 9A, and 9B;

FIG. 11 is a schematic diagram of a second example of a system for implementing the present invention; and,

FIG. 12 is an example of a screen shot showing the world map.

### DETAILED DESCRIPTION OF THE PREFERRED EMBODIMENTS

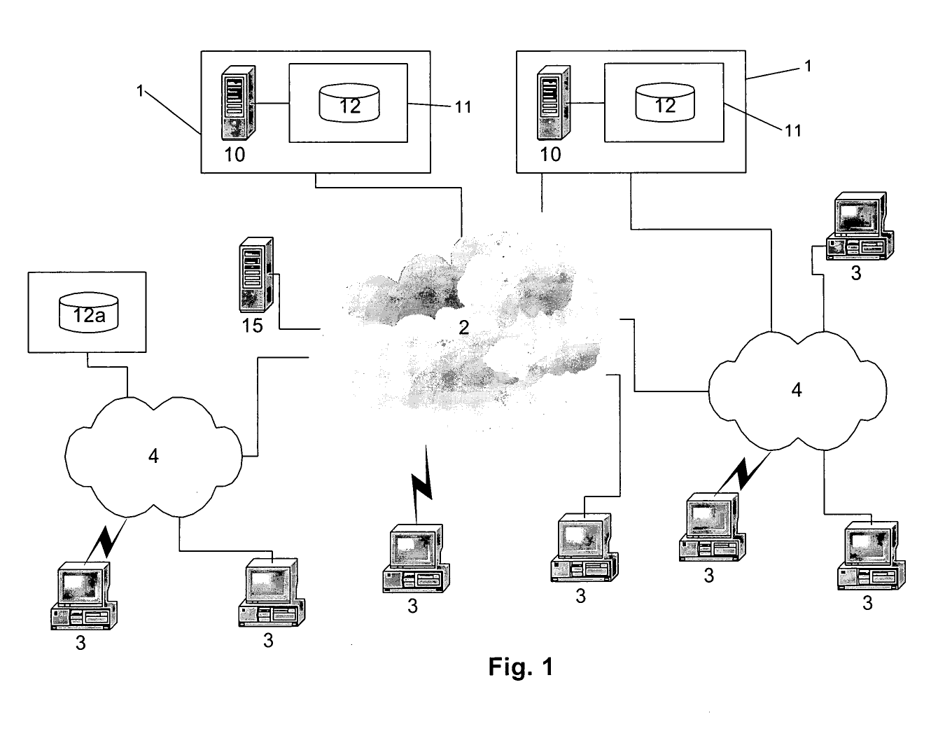

An example of the present invention will now be described with reference to FIG. 1, which shows a system suitable for implementing the present invention.

As shown, the system includes at least two base stations 1 coupled to a number of end stations 3, via a communications network 2, and via a number of local area networks (LANs) 4. Each base station 1 is generally formed from one or more processing systems 10 coupled to a data store 11, the data store 11 usually including a database 12, as shown. In addition to this, a database 12A may also be provided coupled to the LAN 4, as will be described in more detail below.

In use, users of the end stations 3 can access services provided by the base stations 1, allowing the users to encrypt data objects, such as e-mails or the like, before transmitting the encrypted data objects via the communications network 2.

It will therefore be appreciated that the system may be implemented using a number of different architectures. However, in this example, the communications network 2 is the Internet 2, with the LANs 4 representing private LANs, such internal LANs within a company or the like.

In this case, the services provided by the base station 1 are generally made accessible via the Internet 2, and accordingly, the processing systems 10 may be capable of generating web-pages or like that can be viewed by the users of the end stations 3.

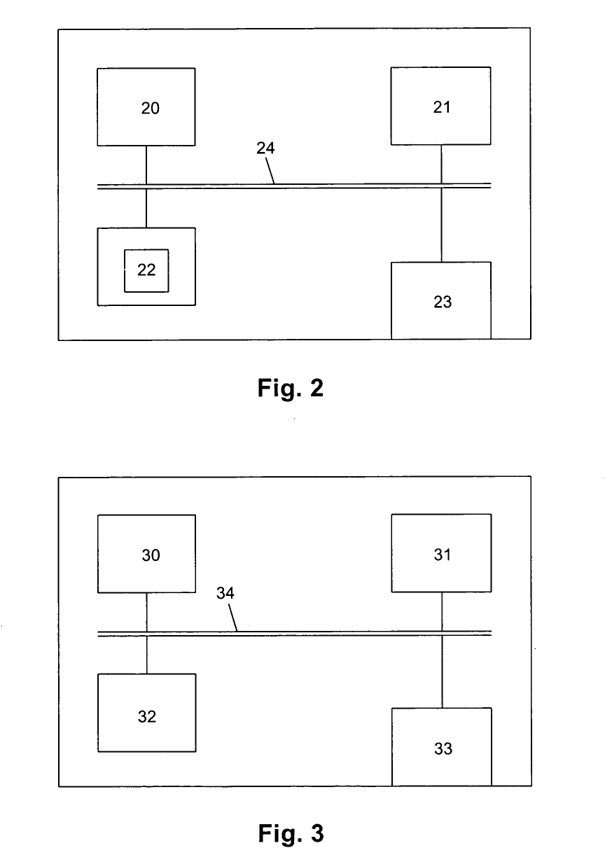

Accordingly, the processing systems 10 may be any form of processing system but typically includes a processor 20, a memory 21, an input/output (I/0) device 22 and an interface 23 coupled together via a bus 24, as shown in FIG. 2. The interface 23, which may be a network interface card, or the like, is used to couple the processing system to the Internet 2.

It will therefore be appreciated that the processing system 10 may be formed from any suitable processing system, which is capable of operating applications software to enable the provision of the encryption and decryption services. However, in general the processing system 10 will be formed from a server, such as a network server, web-server, or the like.

Similarly, the end stations 3 must be capable of co-operating with the base stations 1, as well as browsing any web-pages generated by the processing systems 10, and sending or receiving data objects. Accordingly, in this example, as shown in FIG. 3, the end station 3 is formed from a processing system including a processor 30, a memory 31, an input/output (I/O) device 32 and an interface 33 coupled together via a bus 34. The interface 33, which may be a network interface card, or the like, is used to couple the end station 3 to the Internet 2.

Accordingly, it will be appreciated that the end station 3 may be formed from any suitable processing system, such as a suitably programmed PC, Internet terminal, lap-top, hand-held PC, or the like, which is typically operating applications software to enable web-browsing and e-mail. In the case in which the data objects are e-mail or electronic faxes, the processor may operate specialised applications software created specifically for the encryption task. Alternatively the processor may operate modified versions of existing e-mail and electronic fax software, such as Microsoft Outlook™ or WinFax, which have been modified to provide encryption in accordance with the invention. Other examples will be described below.

Alternatively, the end station 3 may be formed from specialised hardware, such as an electronic touch sensitive screen coupled to a suitable processor and memory, as described in more detail below. In addition to this, the end station 3 may be adapted to connect to the Internet 2, or the LANs 4 via wired or wireless connections. It is also feasible to provide a direct connection between the base stations 1 and the end stations 3, for example if the system is implemented as a peer-2-peer network.

In addition to this, the end stations 3 also include a scanning system 35. The scanning system 35 is adapted to scan a portion of a user and generate biometric data therefrom. Accordingly, the scanning system is generally formed from a hardware device such as an biometric scanner that is capable of scanning a body part, such as an eye retina, iris, thumb print, finger print, or the like.

The biometric scanner is coupled to applications software, which may for example be executed by a specialised processor, or by the processor 30, which operates to generate the biometric data from the scanned image. This is generally achieved by applying a one-way hash type function to the scanned image, to generate a unique representation of the scanned body portion.

However, any system that can determine biometric data that is uniquely representative of the user may be used as the scanning system 35. Thus for example, the scanning system may be adapted to determine a unique identifier based on the users DNA, or the like.

### Overview

The basic technique implemented by the present invention is to allow a sender to encrypt a data object, such as an e-mail, an electronic fax, digital media such as images or video files, or other data file, websites, banking information, or the like. The following examples will focus on e-mails in particular, but are applicable to any form of data object. The sender encrypts the e-mail, or other data object, using their respective end station 3, before transmitting the encrypted e-mail to a recipient located at another one of the end stations 3.

In order to achieve this, the system generates an encryption key based on the biometric data of both the sender and the recipient.

Accordingly, when the recipient receives the e-mail, the recipient must obtain a decryption key that can be used for decrypting the e-mail. In this example, the e-mails are encrypted using an AES or RC4 type encryption, and as a result, the decryption key is identical to the encryption key. However, this is not essential to the invention, and the encryption and decryption keys may therefore be different.

Even in the event that the encryption and decryption keys are different, the decryption key will still be based on the biometric data of both the sender and the recipient. Accordingly, the process of decrypting the e-mail with the generated key allows the recipient to determine that the e-mail has genuinely being sent by the sender. In addition to this, the fact that the decryption key is based on the biometric data of both the sender and the recipient makes it virtually impossible for the e-mail to be decrypted and viewed by any third parties other than the genuine sender and the genuine recipient.

The manner in which this is achieved will now be described in more detail below.

### Detailed Description of the Invention

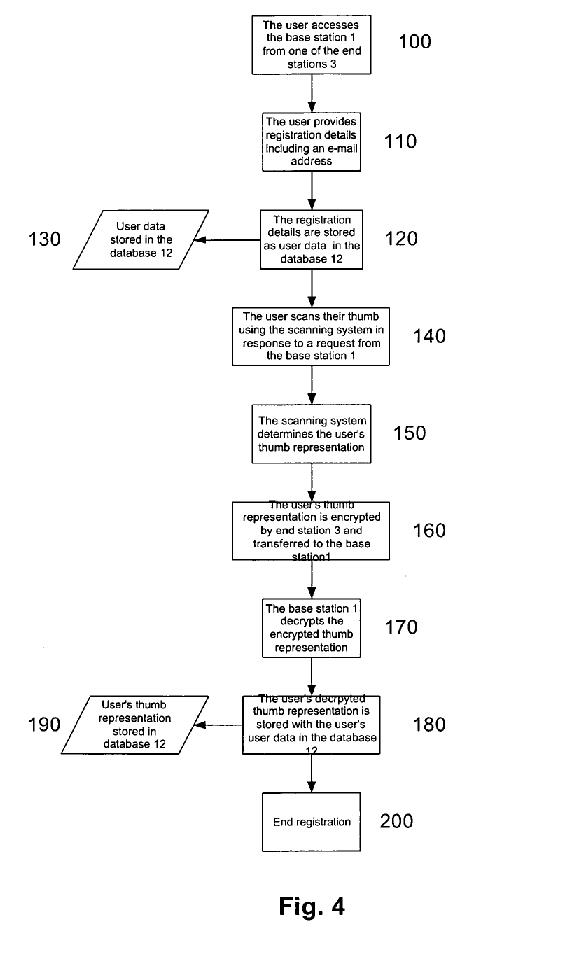

Firstly, in order to be able to use the system, the user will require that encryption applications software is installed on one of the end stations 3. The user must also be a registered user of the system. The registration procedure will typically be implemented when the user initially installs or configures the software, by having the software direct the user through the registration process that involves the provision of biometric data, as outlined in FIG. 4.

Accordingly, as shown at step 100, the user accesses the base station 1 from one of the end stations 3. At step 110 the user provides registration details including at least an e-mail address. This e-mail address is then used to identify the user on subsequent occasions.

However, it also typical for other data regarding the user to be provided. This may include for example payment details for satisfying subscription payments required to access the services provided by the base station 1. Additionally, other security information may be required to allow the operators at the base station 1 to perform additional security checks.

Thus typically the registration process would require the provision of at least a name, address, country and other contact details, as will be appreciated by persons skilled in the art.

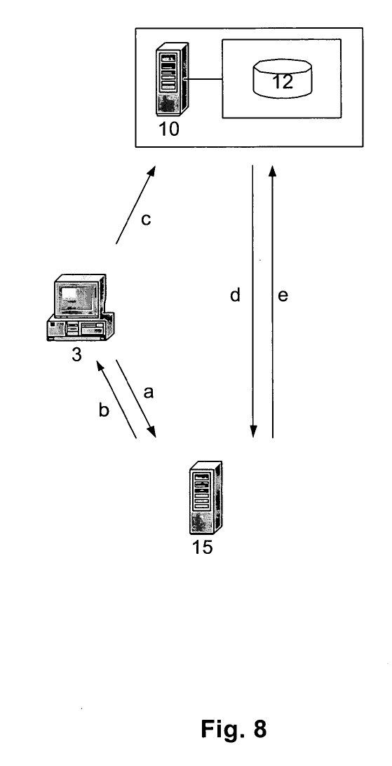

When details are transferred to the base station 1, it is desirable to keep the details secure. Accordingly, the details may be encrypted and/or transferred via a 128-bit SSL connection. If additional encryption is used, this may be achieved in the manner described below with respect to FIG. 8.

Once the required registration details have been provided, the registration details are stored in the database 12 at steps 120, 130 as shown. In general, the registration details as stored as user data within the database 12 located at the respective base station 1. This means that each base station 1 may retain user details of respective users in the respective database 12.

The base stations 1 are generally distributed geographically so that each base station provides coverage for a respective geographical area. As a result of this, when users register, they will generally be directed to a base station 1 covering their geographical location. Thus for example, the base stations may be distributed with one base station per continent, or per country, depending on the number needed. Each base station would then hold user data regarding users located in the respective area, with users located in different areas having user details retained on a different database 12.

In addition to this however, user details can also be stored on databases that may for example be provided on a local area network such as the LAN 4, as shown for example by the database 12a. This may be required for example if the user is a member of a company that wants to ensure that all the details of employees and/or clients are retained on a private database 12a that cannot be accessed other than via the LAN 4.

In this case, the registration procedure may be implemented by one of the base stations 1, with the registration details being stored in the database 12a instead of the database 12. Alternatively, the registration procedure may be performed by a processing system (not shown) coupled to the LAN 4, or even by applications software executed by the end station 3 itself.

In any event, once the registration details are stored in one of the databases 12, the user uses the scanning system 35 to scan their thumb, in response to a request from the base station 1.

At step 150, the scanning system 35 uses the scanned image to determine the user's thumb representation. The thumb representation is a digital representation of the user's thumb print which is formed by applying a predetermined one way hash function to the image generated by the optical scanner that forms part of the scanning system 35. As each users scanned thumb image will be different, the resulting thumb representation is unique for each user, and will in fact be unique for each individual person.

Once the thumb representation has been generated by the scanning system, the thumb representation is encrypted by the end station 3 and transferred to the base station 1. Again the encryption is performed to ensure the thumb representation cannot be viewed by third parties. The encryption may be any form of encryption. However, the encryption is preferably achieved by having the end station obtain an encryption key from a key server 15, as will be described in more detail below with respect to FIG. 8.

The encryption algorithm used is not particularly important to the present invention, and it will be appreciated that a number of different encryption techniques such as AES (Advanced Encryption Standard) RC4, RSA or the like, can be used. However, in the current example AES encryption is used.

In addition to ensuring that the thumb representation is encrypted, the connection between the base station 1 and the end station 3 operates over a given port to provide additional security. However, it will be realised that other techniques, such as 128-bit SSL (Single Socket Layer) connection, could be used.

The thumb representation is encrypted and transferred to the base station 1 at step 160. At step 170 the base station 1 decrypts the encrypted thumb representation, using an encryption key. Again the encryption key will preferably be obtained from the key server 15, as described below with respect to FIG. 8.

Once the thumb representation has been decrypted, it is stored together with the user's user data in the database 12, or the database 12A, as shown at 180 and 190. The registration procedure then ends at step 200.

At this point the base station 1 may generate a number referred to as a Quick Access Number (QAN) which is unique to the user. This can be used to uniquely identify the user in due course, as will be explained in more detail below. Typically the QAN is a unique 6 digit alphanumeric string, although other combinations of characters and string lengths may be used.

Once the registration is complete, it is then possible to send encrypted e-mails or other data objects to any other registered user of the system.

It will be appreciated that the process may be, modified if alternative biometric data, such as a face, iris, or retina representation is used. In this example, the user will scan the respective body portion to allow a respective representation to be generated. The remainder of the description focuses on the use of thumb representations, although it will be appreciated that any biometric data may be used.

In the present example, when the user registers with the system, the user's user details will only be stored in the database associated with the base station with which they are registered. Thus, the user's details will not be stored on each of the databases 12.

The reason for this is that in order to help implement a readily scalable architecture, the system is generally configured with each base station 1 being assigned to a respective geographic area. It will be appreciated by persons skilled in the art that this does not require the base stations 1 to actually be located at different locations, but rather each base station 1 is adapted to handle user's from respective areas.

Accordingly, when users initially registers, the user will be assigned to one of the base stations 1 based on the geographical location indicated in their provided registration details. Thus for example, one base station 1 may be provided to handle all users in a given country. Accordingly, all users who indicate that respective country in their registration details will be assigned to that respective base station.

The purpose behind this is to ensure that each base station 1 does not have to handle a large amount of processing and data. Thus, when the system is initially configured, the number of users will be relatively small, and accordingly, only a few base stations 1 will be required to provide the service world-wide. However, as the number of user's expand, the amount of processing and data handling for the entire system will increase.

Accordingly, the invention allows the additional base stations 1 to be assigned to a given geographical area in which the processing and data handling requirements are excessive. In this case, some of the users may be transferred from one base station to another in accordance with their indicated country, when the number or geographical assignment of the base stations 1 change. This base station 1 will then handle the validation of any user's registered herewith, as will be explained in more detail below.

The encryption software installed on the end station will vary depending on the intended use of the encryption system. Thus for example, the software would typically include an e-mail system that can be used by the sender to transfer an e-mail. Additional facilities, such as file transfer, chat, web-access, financial transaction functionality and the like may also be provided either incorporated in a single application, or provided as separate applications software.

In any event, the nature of the applications software will vary depending on the particular implementation of the invention. The present example relates to proprietary applications software known as “ThumbSecure e-Mail”. However, for example, the individual may use standard existing e-mail applications software, such as Microsoft's Outlook™, or the like to create the e-mail. The e-mail could then be encrypted using a separate encryption application. Alternatively, the encryption could be provided by an add on that interacts with Outlook.

Alternatively, separate e-mail applications software such as “ThumbSecure e-Mail” could be provided to the end station 3. This may either be purchased in the normal way, or could be provided by download from the base station 1, for example at the end of the registration procedure.

A final option is for the e-mail applications software to be executed by the base station 1, such that the user may use any end station to access the e-mail system. In this case, the e-mail system will function in a similar manner to “Hotmail”, or the like. It will be appreciated that in this case, the user will only be able to send encrypted e-mails if the end station includes a scanning system 35. However, in general the e-mail system will allow unencrypted e-mails to be transferred.

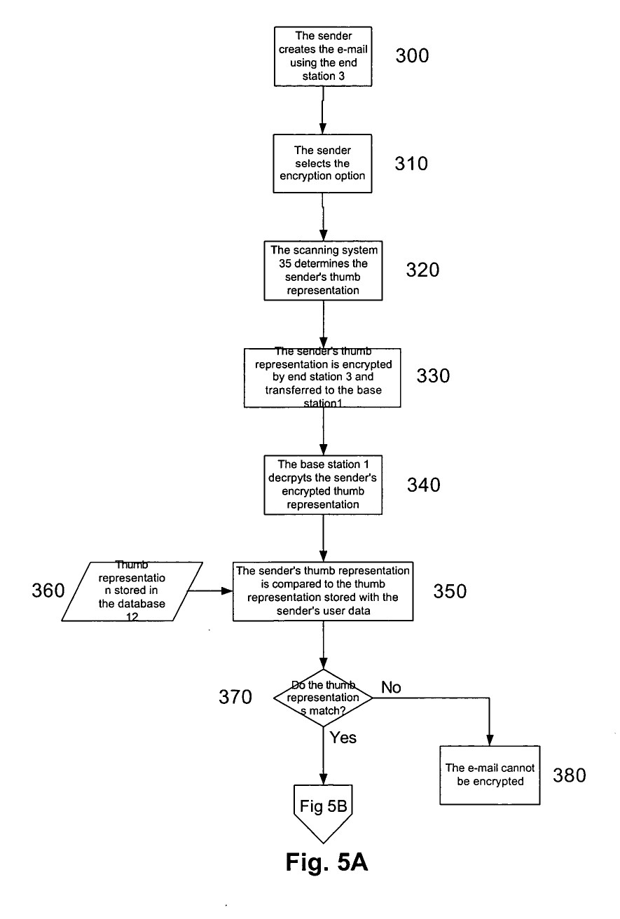

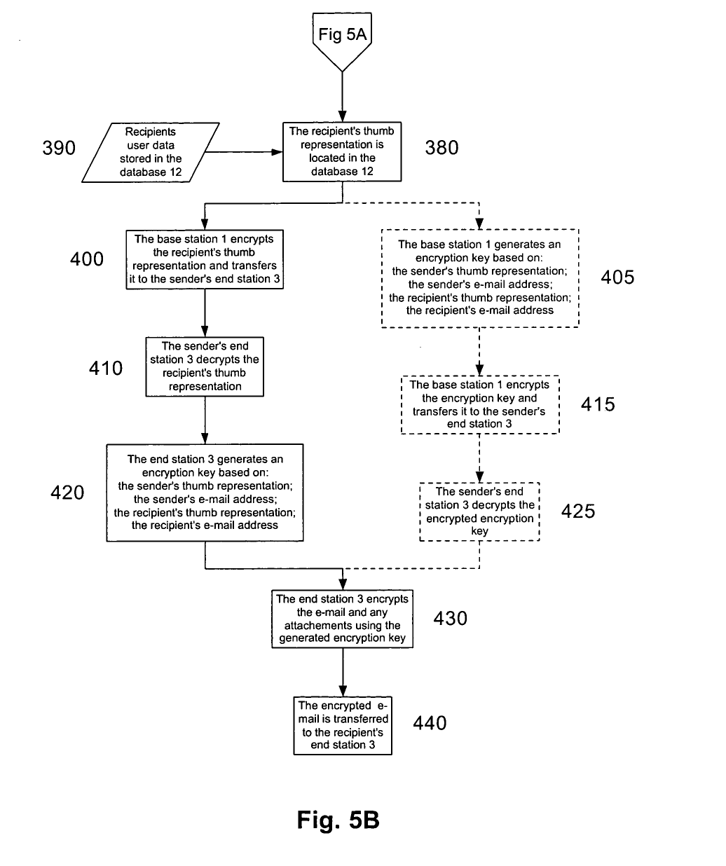

The manner in which a sender encrypts an e-mail will now be described with reference to FIGS. 5A and 5B.

Firstly, at step 300 the sender creates an e-mail or other data object to send using the end station 3. In this regard, the end station 3 will generally be provided with an applications software program, which when executed by the processor 20 is capable of generating e-mails and then encrypting them in accordance with the present invention. It will be realised that this software application may be purchased and installed on the end station 3. Alternatively however the application software necessary for implementing the present invention may be downloaded to the end station 3 during the registration process, or may be provided as part of the end station software the end station 3 is purchased, or purchased from the Internet 2.

In any event, the application software will allow the sender to select an encryption option at 310. Once this has been completed, the scanning system 35 is activated and used to scan the sender's thumb to determine the sender's thumb representation at step 320.

It will be appreciated that it is important that third parties are not able to monitor communication between the end station 3 and the base station 1 and determine the sender's thumb representation. Accordingly, the sender's thumb representation is encrypted by the end station 3 before being transferred to the base station 1 at step 330. Again, the encryption used to encrypt the thumb representation will preferably involve obtaining an encryption key from a remote processing system, as will be described in more detail below. The connection will also generally be via a given, although a 128-bit SSL connection could be used.

In any event, when the base station 1 receives the encrypted thumb representation, this is decrypted at step 340.

The sender's thumb representation that has been decrypted by the base station 1 is then compared to the thumb representation stored with the sender's user data at steps 350 and 360. Thus, when the end station 3 transfers the sender's thumb representation to the base station 1, this will typically be achieved by transferring not only the thumb representation but also the sender's e-mail address or QAN. The sender's e-mail address or QAN is then used to locate the sender's user data in the local database 12, allowing the sender's thumb representation stored during the registration process to be accessed. This is typically achieved by having the user data indexed using the respective user's email address or QAN.

It will be appreciated by a person skilled in the art that if the sender's thumb representation and user data are stored in the database 12a, then the base station 1 may have to arrange for the thumb representation to be temporarily transferred to the base station 1 to allow the procedure to be implemented.

Alternatively, instead of having the end station 3 transfer the sender's thumb representation to the base station 1, the thumb representation may be transferred to another processing system, for example a processing system (not shown) attached to the LAN 4. This processing system could perform the functionality of the base station 1.

Finally, in the event in which the LAN 4 is for example part of a business or the like, the steps otherwise performed by the base station 1 may be performed by the end station 3. It will be appreciated that this may be advantageous, as the thumb representation will not need to be encrypted and transferred to the base station 1. In any event, whether the following procedure is performed by the base station 1 or the end station 3 the general method is the same.

Thus, at step 360, it is necessary to compare the sender's thumb representation, with the thumb representation stored in the user data of the sender to validate the identity of the sender.

A person skilled in the art will appreciate that when this is performed it is necessary for the thumb representations to be normalised. In particular, the thumb representation is derived by applying a one-way hash function, or the like, to a scanned image. Accordingly, if a user's thumb is positioned on the scanner at different location each time the thumb is scanned, a different thumb representation will be generated. However, it is possible to overcome this by normalising the thumb representations so that the thumb representation is effectively invariant on the location of the thumb on the scanner.

As a result, the normalised thumb representations can be compared directly irrespective of the location of the user's thumb on the scanner.

If the thumb representations do not match at step 360 then this indicates that the, individual attempting to send the e-mail is not in fact the genuine sender. In other words, the sender is an individual trying to fraudulently use the e-mail address of the genuine sender.

Accordingly at this stage the base station can indicate that the validation of the sender has failed. The process ceases and the e-mail cannot be encrypted at step 370. In this regard, the base station can be adapted to monitor for any such events, such that if a number of unsuccessful validation attempts are made, the respective users account could be frozen until an explanation for the failed validations can be determined. This can help reduce the chances of fraudulent use of the system.

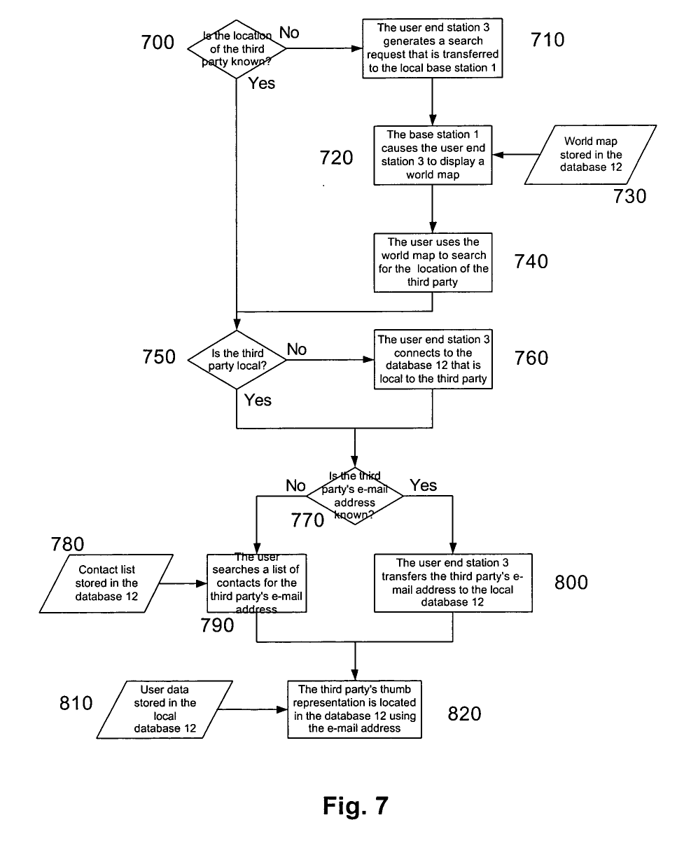

In the event that the validation is successful, the process continues at steps 380 and 390. At this stage, the recipient's thumb representation is located in the recipient's user data stored in one of the databases 12. This is achieved by using either the e-mail address or QAN of the intended recipient that is provided by the end station 3. It will be appreciated from the above, that the recipient's thumb representation may be located in a different database 12, and the manner in which this is handled will be described in more detail below with respect to FIG. 7.

It will also be appreciated from this that the recipient (or indeed any user of the system) may be identified using an e-mail address or QAN. However, in one example, the QAN is retained confidential to each user (in a similar manner to a Personal Identification Number “PIN”) so that users can identify themselves using a QAN whilst third parties must identify them using another public identifier such as the e-mail address.

Once the recipient's thumb representation has been located, the base station 1 encrypts the recipients thumb representation and transfers it to the sender's end station 3 at step 400. Again, this is performed via a 128-bit SSL connection, using known encryption algorithms and an encryption key obtained from a remote processing system, as will be described in more detail below.

At 410 the sender's end station 3 decrypts the recipient's thumb representation before generating an encryption key based on the sender's thumb representation, the sender's e-mail address, the recipient's thumb representation, and the recipient's e-mail address. Again QANs of the sender and/or recipient may be used instead of (or in addition to) the sender or recipient's e-mail addresses. This is performed by the processor 30 under the control of the applications software being executed thereon, at step 420.

As an alternative to steps 400 to 420 described above, the system can alternatively be adapted to cause the base station 1 to generate the encryption key.

In this case, at step 405, the base station 1 generates the encryption key using the processor 20. Again, this is based on the sender's thumb representation, the sender's e-mail address, the recipient's thumb representation, and the recipient's e-mail address. In this case the sender's thumb representation is the thumb representation used in the comparison at step 350 above.

At step 415, the base station 1 encrypts the generated encryption key and transfers the encrypted encryption key to the end station 3, for subsequent decryption at step 425.

It will be appreciated that this technique has the added benefit that the recipient's thumb representation itself is not received by the end station 3, thereby preventing the recipient's thumb representation being fraudulently used by the recipient. Furthermore this allows the process to be implemented without any thumb representations being transferred from the base station, thereby helping to further improve the overall security of the system.

In this example, the encryption technique used is AES based. As mentioned above, the encryption key is based on a concatenation of the sender's thumb representation, the sender's e-mail address (and/or QAN), the recipient's thumb representation, and the recipient's e-mail address (and/or QAN). As a result, this defines a unique variable that is impossible to determine without knowledge of the constituent components. Accordingly, this defines an encryption key that cannot be determined by third parties.

In general, encryption keys generated by this process have a maximum length of 14336 bits (1792 characters) and a minimum length of 12928 bits (1616 characters), thereby making it impossible to determine the key from an analysis of the encrypted information. However, alternative key lengths may be used as appropriate. Furthermore, the encryption keys themselves may be formed using a one way technique such as using a one way hash function, or the like, to prevent any of the information contained therein from being extracted. Accordingly, even if any three of sender's thumb representation, the sender's e-mail address (or QAN), the recipient's thumb representation, and the recipient's e-mail address (or QAN) are known, it is not possible to determine the fourth unknown representation or e-mail address (or QAN) from the encryption key.

Once the end station 3 has the generated encryption key, the end station proceeds to encrypt the e-mail and any associated attachments at step 430.

As will be appreciated by a person skilled in the art, as the encryption key is based on the recipient's e-mail address and thumb representation, if the e-mail is to be sent to multiple recipient's, then multiple encryption keys will be generated. A separate copy of the e-mail will then be encrypted for each recipient, using the encryption key based on the recipient's biometric data. Thus, for example, if the e-mail is sent to ten individuals, then ten encryption keys will be generated, with each key being used to encrypt a respective copy of the e-mail.

However, whilst this is the default procedure, it will be appreciated that variations are possible. Thus, for example, if the e-mail has a main recipient, and a number of copied recipients, the encryption key may be based solely on the main recipient, with the copied recipients only being able to access the e-mail once the main recipient has decrypted it. In this case the decryption key generated for the main recipient may therefore be transferred to all other recipients to allow decryption of the respective copies of the e-mails.

As shown at step 430, 440, once the encryption is completed, the encrypted e-mail is transferred the recipient's end station 3 via the Internet 2, the LAN 4, or another suitable communications system, as appropriate.

It will be appreciated from the above, that as the encryption key is based on the recipient's and the sender's biometric data, the recipient can be confident firstly that the indicated sender is the genuine sender and secondly that the e-mail cannot be opened by third parties.

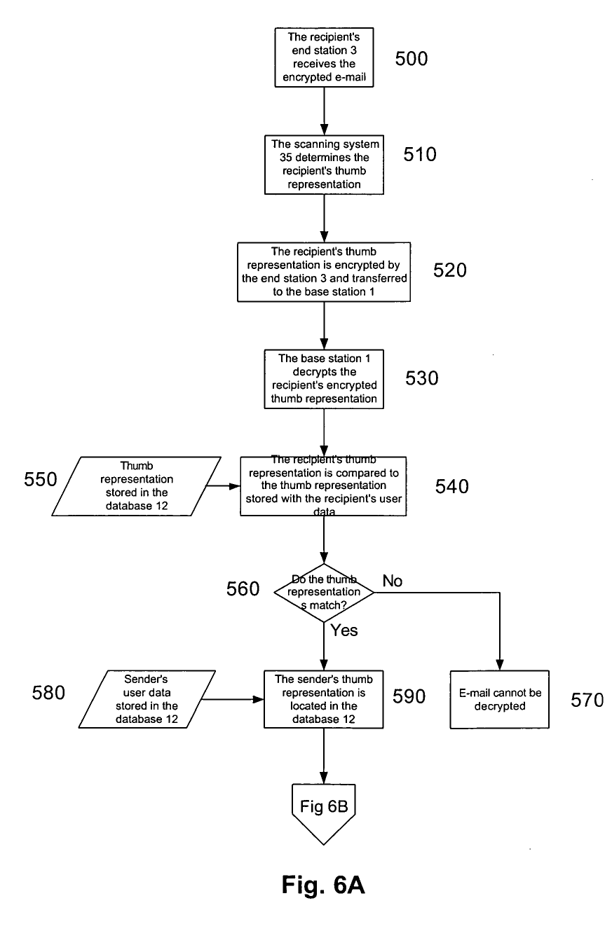

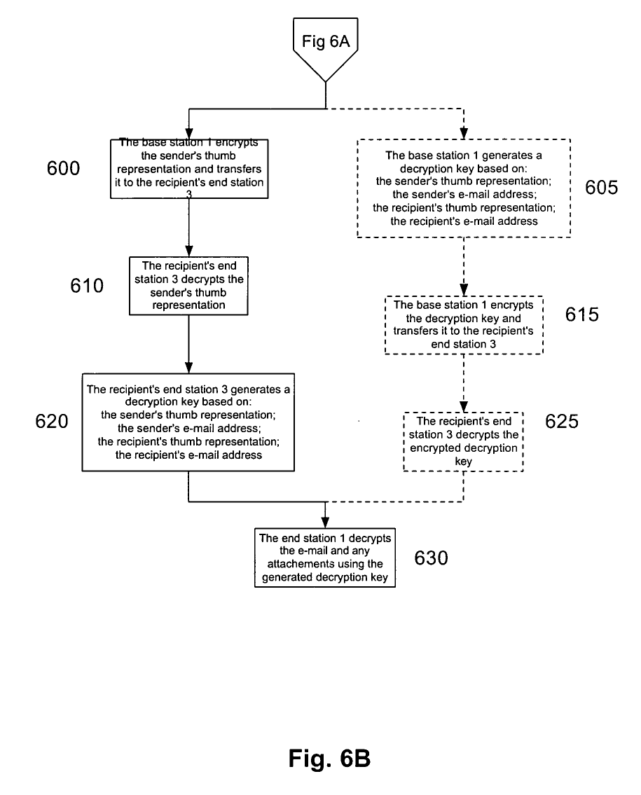

The decryption process will now be described with reference to FIG. 6A and 6B.

As shown in FIG. 6A, the first step is for the recipient to receive the e-mail at step 500.

The next stage in the process is to validate the authenticity of the recipient, and in particular, to confirm that the recipient is the actual individual that is assigned the recipient e-mail address. This process is similar to the validation of the sender prior to encrypting the e-mail.

Accordingly, at step 510 the scanning system 35 operates to determine the recipient's thumb representation or other biometric data. At step 520 the recipient's thumb representation is encrypted by the end station 3 and transferred to the base station 1. As in the case above with respect to the transfer of the sender's thumb representation, this is achieved by encrypting the thumb representation using a known encryption algorithm and an encryption key generated by a remote processing system, as will described in more detail below.

At step 530 the base station 1 decrypts the recipient's encrypted thumb representation. At steps 550 and 540 the base station 1 then uses an indication of the recipient such as the recipient's e-mail address or QAN to obtain the thumb representation stored with the recipients user data in the local database 12 (or in the database 12A). This thumb representation stored in the database 12 is then compared to the received recipient's thumb representation to determine if the thumb representations match.

Again, this comparison step may require normalisation of the thumb representation to take into account any variations in the generation of the thumb representations, as described above with respect to the encryption process.

If it is determined that the thumb representations do not match at 560, then the base station 1 determines that the recipient is not the genuine recipient. In particular, this indicates that a third party has attempted to open the recipient's e-mail and accordingly, the system halts the procedure so that the e-mail can be not be decrypted at step 570.

If however the thumb representations match then the sender's thumb representation is located in the database 12 at 580 and 590. The manner in which this is achieved will depend on the geographical location of the sender, as will be described in more detail below.

As shown at step 600, the base station 1 then encrypts the sender's thumb representation and transfers it to the recipient's end station 3.

At step 610 the recipient's end station 3 decrypts the sender's thumb representation and uses this, together with the recipient's own thumb representation, the sender's e-mail address (and/or QAN) and the recipient's e-mail address (and/or QAN), to generate a decryption key at step 620.

Alternatively, as shown at 605 the base station 1 can operate to generate the decryption key using the sender's thumb representation, the sender's e-mail address (and/or QAN), the recipient's thumb representation, and the recipient's e-mail address (and/or QAN). The base station 1 then encrypts the description key and transfers this to the recipient's end station 3 for decryption at steps 615, 625.

Again, this ensures that the sender's thumb representation is retained secure at the base station 1, preventing it being fraudulently received or used by the recipient or other third parties.

The end station 1 then decrypts the e-mail and any attachments at step 630, using the generated decryption key, thereby allowing the recipient to view the e-mail.

It will be appreciated that whilst the above has been described with respect to a database 12 positioned at the base station 1, the database 12A may not be located with an associated base station. Thus, as briefly outlined above, the database 12A may store the one of the sender or recipient's details.

Furthermore, different base stations 1 are provided in different geographical locations. When accessing a base station 1, the end station 3 will be connected to the base station 1 based on the country indicated in the registration details, as described above. Accordingly, the sender or recipient's details may not be directly available to the end station 3. In this case, the database 12 in which the thumb representation is located must first be determined. The manner in which this is achieved will be described in more detail below.

However, it will be appreciated from this that the end station 3 may be required to locate the thumb representation from the database 12a. In this case, the base station 1 may not be required, allowing the end station 3 to perform the validation steps, such that the method outlined in FIGS. 6A and 6B is completed by the end station 3 without using the base station 1.

However, it will be appreciated that there may be less security in this, as the end station 3 may be compromised thereby reducing the effectiveness of the system.

In any event, when a user attempts to send or receive an e-mail, it is necessary for the user or base station 1 to determine the thumb representation of the recipient or the sender (hereinafter referred to as the third party thumb representation).

As mentioned above, the storage of user data is based on the geographical location of the user. This is to allow the distribution of processing to be divided between a number of different base stations 1 to thereby provide a scalable architecture.

In this case, the database on which the thumb representation of the third party is stored will depend on the geographical location of the third party and hence, to which base station 1 the user has been allocated. Accordingly, to allow a user to encrypt an e-mail, the user must be able to locate the thumb representation of the third party by determining to which base station 1 the third party is allocated.

The process for achieving this outlined in FIG. 7.

Thus as shown, at step 700 it is necessary to determine whether the location of the third party is known. If the location of the third party is not known, the user will use the end station 3 to generate a search request that is transferred to the base station 1 which is geographically closest to the user, known as the local base station.

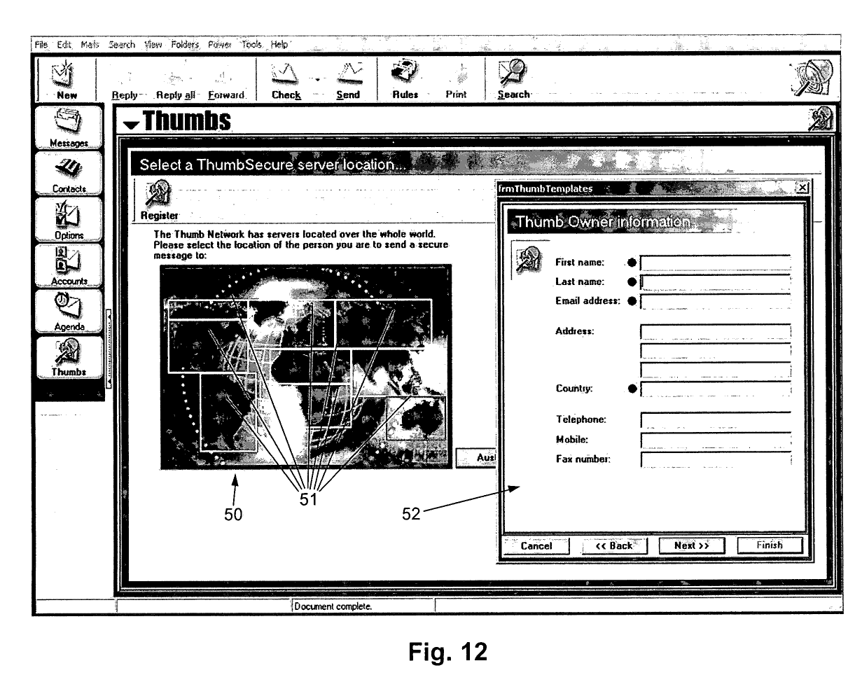

At steps 720 and 730 the base station 1 causes the user end station 3 to display a world map based on a world map stored in the database 12. The user 740 uses the world map to search for the location of the third party. An example of this is shown in FIG. 12.

As shown the world map 50 is divided into a number of regions 51, allowing users to select the region in which the recipient is located. The user can then search the respective region for the recipient using search screen 52. This causes the base station 1 to perform a search of the database 12 associated with the respective base station 1.

From this, it will be appreciated that the world map contains details of the location of each user registered with the system. In order to maintain this, the world map stored in the database 12 must be regularly updated such that each base station 1 and each database 12 includes an identical replica of the world map.

In any event, once the location of the third party is known it is determined whether the third party is local. If the third party is not local then the user end station 3 is transferred to the database 12 that is local to the third party. Thus for example, the end station 3 may be re-connected to a base station 1 that is on the opposite side of the world.

Alternatively, the end station 3 may be connected to the database 12A located on the LAN 4. It will appreciated however that is typically only possible for the end stations 3 also located on the LAN 4 as external access to the LAN is not necessarily provided.

In any event, once the user's end station has connected to the local database 12, the user is asked whether they know of the third party's e-mail address or QAN (the remaining description will focus in the use of an e-mail address, although QAN's may also be used) at step 770. If the user does not know the third party's e-mail address a contact list stored on the database 12 is displayed to the user at 780 and 790, allowing the user to search through the contacts for the third party's e-mail address. Alternatively, if the user is aware of the e-mail address the user is asked to enter the e-mail address at the end station 3. The e-mail address is then transferred to the local database 12 at step 800.

Finally, at steps 810 and 820 the third party's thumb representation is located in the database 12 using the third party's e-mail address.

Accordingly, it will be appreciated that the above technique applies both to finding the recipient's thumb representation in the encryption process, and to finding the sender's thumb representation in the decryption process. Also the process can be implemented to allow the user to determine the location of the third party with this information being used to allow the third party thumb representation to be obtained by the base station 1 local to the user. This allows the base station 1 to generate the encryption or decryption keys as described above with respect to steps 405, 415, 425 or 605, 615, 625 respectively.

Finally, the manner in which the thumb representations are encrypted for transfer between the base station 1 and the end station 3 will now be described.

In particular, it is important that the thumb representations cannot be determined by third parties that are monitoring connections between the end station 3 and the base station 1, between the respective base stations 1. This is because if the third parties were able to obtain the thumb representations of users registered with the system, they would then be able to masquerade as the users.

Accordingly, in order to ensure the safety of such data the connections between the base station 1 and the end stations 3 are implemented as designated port connection, although as an alternative 128-bit SSL encrypted connections, or better, can be used depending on the implementation. In addition to this, the thumb representations are encrypted before transfer. This level of encryption is above and beyond that provided by the 128-bit SSL connection.

In order to ensure that the encryption cannot be broken, a random encryption key is used each time a thumb representation is encrypted. The encryption used is AES or RC4 encryption and, accordingly, it is necessary for the representation to be decrypted using the same key. In order to achieve this therefore it is necessary for both the end station 3 and the base station 1 to be provided with identical keys. In order to achieve, the system makes use of the remote key server, shown as 15 in FIG. 8.

In use, the key server 15 would be similar in form to the processing system 10 shown in FIG. 2.

Operation of the system will now be described with reference to an example in which the end station 3 is to transfer the thumb representation to the base station 1. In this example, the end station 3 will initially request a key from the key server 15 as shown by the arrow (a).

A key is generated by the key server 15 and transferred to the end station 3 via an SSL connection, as shown at (b). In this regard, the key can also be additionally encrypted using for an example an alternative encryption technique with known encryption and decryption keys being provided at the end station 3, the base station 1 and the key server 15. This could for example be through the use of a public/private key system, such as RSA encryption.

Once the key has been received by the end station 3, the end station 3 operates to extract the encryption key and use the encryption key to encrypt the thumb representation, and any additional information, which is then transferred to the base station 1 as shown at (c).

The base station 1 receives the encrypted thumb representation and requests a decryption key from the key server 15 as shown at (d). The key server 15 transfers the required decryption key back to the base station 1 at (e), allowing the base station 1 to decrypt the encrypted thumb representation.

It will be appreciated from this that a similar technique can be used to allow information to be transferred from the base station 1 to the end station 3 or between base stations 1.

Furthermore, because the encryption key is never transferred directly between the base station 1 and the end station 3, it is unlikely that the encryption key will be determined. This is because any individual attempting to obtain the thumb representation will typically focus on the connection between the end station 3 and the base station 1. Accordingly, in this case, any such individual would only be able to detect the encrypted thumb representation, and never a decrypted thumb representation of or key.

In addition to this, in order to ensure that the encryption key remains secret, as soon as the encryption key has been used to encrypt the representation the encryption key is wiped from the end station memory 31. Similarly, as soon as the encryption key has been used by the base station 1 it is wiped from the base station memory 21, and from a memory in the key server 15 such that the encryption key is no longer in existence.

Accordingly, the use of the remote key server allows the end station 3 and the base station 1 to transfer information there between with a greater level of security. This is because although both the end station 3 and the base station 1 require the same encryption key, the key itself is never transferred directly between the two machines. This therefore greatly reduces the risk of the key being intercepted and used to decrypt the thumb representations being transferred.

In addition to the e-mail functionality outlined above, the present invention can also provide the ability to “chat” in an encrypted fashion. This is achieved in a manner similar to normal chat environments but utilising the encryption technology provided by the present invention. Accordingly, this allows individuals to chat in a secure manner by transferring encrypted text in real time between two end stations 3, via the Internet 2. In this case, using the techniques of the invention, the text is encrypted using the thumb representations of the two parties involved.

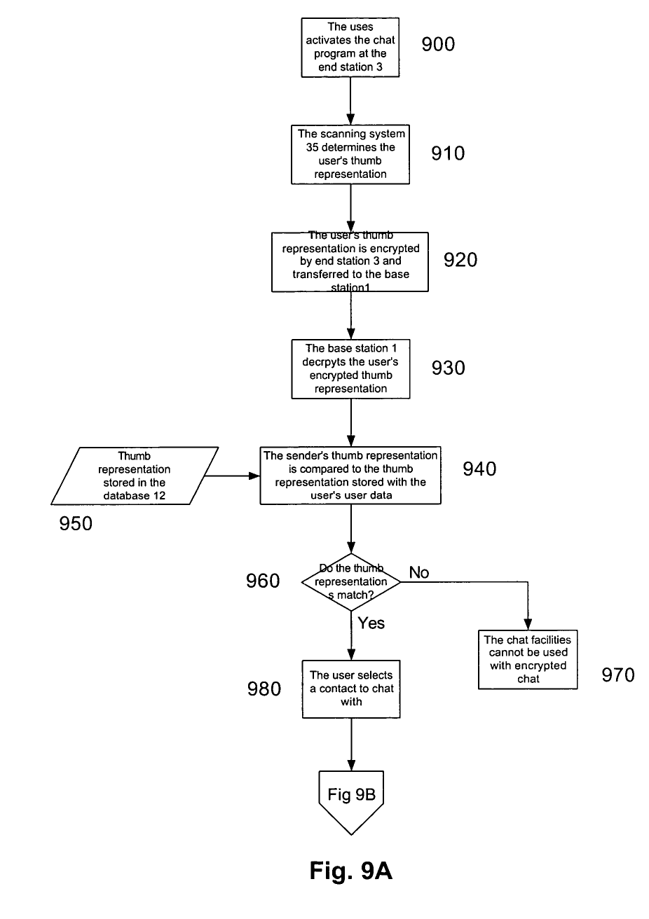

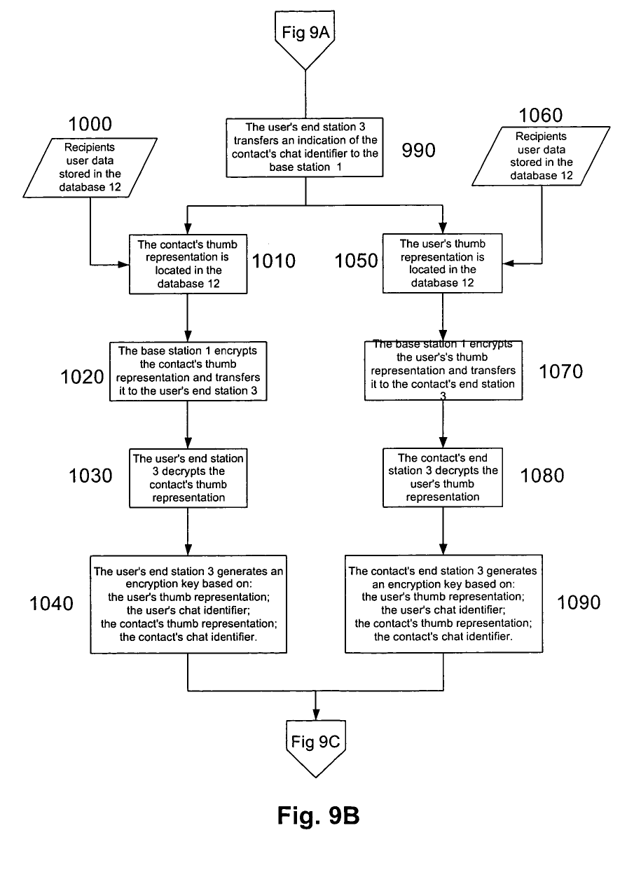

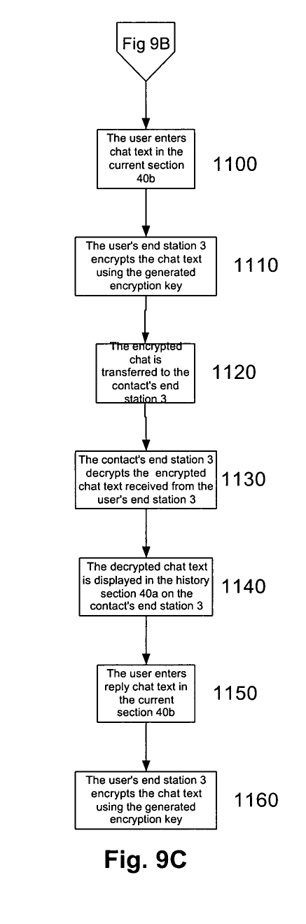

The process for achieving this will now be described with reference to FIG. 9A and FIG. 9B.

Firstly, at step 900 a user of one of the end station 3 activates a chat program on their end station 3. It will be appreciated by a person skilled in the art that the chat program may be an application software running on the processor 30, or alternatively may be applications software running on an appropriate one of the base stations 1.

In any event, when the chat application is initially activated the user will be asked to validate themselves in a manner similar to the validation performed with respect to the sender and the recipient in the e-mail process described above.

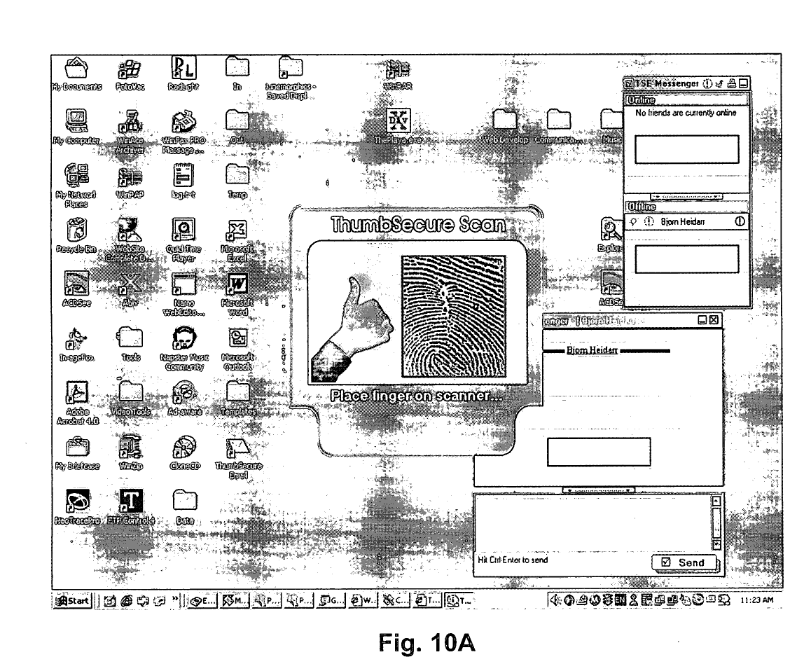

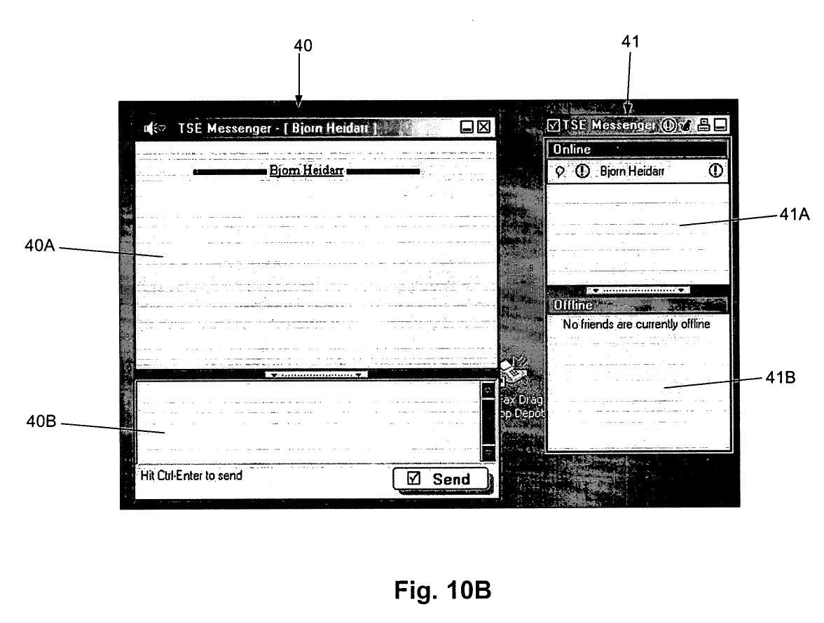

Thus at step 910 the user will be asked to generate a thumb representation using the scanning system 35. An example of a typical screen shot displayed by the end station 3 asking the user to scan their thumb is shown in FIG. 10A. The scanning system 35 will determine the users thumb representation at step 910.

At step 920 the user's thumb representation is encrypted by the end station 3 and transferred to the base station 1. This encryption may be achieved in any way, but typically, this is achieved using the three-way encryption system in which an encryption key is obtained from a remote key server 15, as described for example with respect to FIG. 8.

Once the base station 1 has received the encrypted thumb representation, the base station 1 decrypts the thumb representation at step 930. The user's thumb representation is then compared to the thumb representation stored with the user's user data in the database 12, at steps 940 and 950. In this case, the user's thumb representation stored in the database 12 will be located using one or more of a chat identifier, e-mail address or QAN.

Accordingly, from this it will be appreciated that in order to utilise the chat system, the user must initially be validated by the base station 1 assigned to the user's geographical area.

At step 960 it is determined if the thumb representations match by the processing system 10. It will be appreciated that in order to achieve this the thumb representation stored in the user data and the received thumb representation must be normalised to allow a direct comparison to be achieved, as described in more detail above with respect to the e-mail process.

If the thumb representations do not match, the base station 1 determines that encrypted chat cannot be performed at step 970. In this circumstance, the user can optionally be provided with the choice of chatting in an unencrypted fashion depending on the implementation of the invention. However, in this example because the validation is performed to check that the user is genuinely the user indicated then failure of validation step will prevent the chat facility being used at all.

In the event that the thumb representations are deemed to match the user then selects a contact with whom to chat at 980.

The manner in which this is achieved will depend upon the particular implementation of the chat applications software. Thus for example, it will be appreciated that encrypted chat may be provided as an add on to currently existing applications software such as the MS Messenger Chat Service.

However, in the present example, the user is presented with a screen similar to the screen shown in FIG. 10B. As shown the screen contains a chat dialogue screen 40 and a contact dialogue screen 41. A send button 42 is also provided.

The chat dialogue screen 40 includes a history section 40a and a current section 40b. The history section 40a will display the history of any chat performed so far whilst the current section 40b is used by the user to enter new chat text to send to any other contacts in the current conversation. The text can be sent using the send button 42.

The contact dialogue screen 41 includes an online section 41a and offline section 41b. This is used to indicate whether any contacts identified in a friend list are currently online. Thus for example, if any friends are online their names will appear in the online section 41a while if the friends are offline their names will appear in the offline section 41b.

Once the user has selected a contact from the online section 41a an indication of the contact's chat identifier identity will be transferred to the base station 1, at 990. The contact may additionally or alternatively be identified using an e-mail address QAN or the like. For simplicity however the remaining description will focus on the use of a chat identifier only.

At steps 1000 and 1010 the contact's thumb representation is located in the database 12. The base station then encrypts the contact's thumb representation, together with a chat identifier and transfers them to the user's end station 3 at step 1020. The chat identifier is used to identify the user for the purposes of chatting. While any form of identifier, such as the user's name or QAN may be used, typically the chat identifier is based on the user's e-mail address.

Again, as will be appreciated by a person skilled in the art, the encryption of the contact's thumb representation is preferably performed in accordance with the methods described with respect to FIG. 8.

At step 1030 the user's end station 3 decrypts the contact's thumb representation.

At step 1040 the user's end station uses the decrypted thumb representation to generate an encryption key. In this example, the encryption key is based on the user's thumb representation, the user's chat identifier, the contact's thumb representation and the contact's chat identifier.

It will be appreciated that the encryption key may be generated by the base station 1 and be encrypted before being transferred to the end station 3, in a manner similar to that described above with respect to steps 405, 415, 425.

Simultaneously, when the indication of the contact's chat identity has been transferred to the base station 1, at step 990, the base station 1 operates to locate the user's thumb representation in the database 12 at 1050 and 1060. The user's thumb representation is encrypted by the base station 1 and sent to the contact's end station 3 at 1070. At 1080 the contact's end station 3 decrypts the thumb representation and then uses this at step 1090 to generate an encryption key. This encryption key is based on the user's thumb representation, the user's chat identifier, the contact's thumb representation, and the contact's chat identifier.

Again the decryption key may be generated by the base station 1 in a manner similar to that described in steps 605, 615, 625.

At step 1100 the user enters chat text in the current section 40b and selects the send button 42. The end station 3 can encrypt the chat text using the generated encryption key at 1110. The encrypted chat text is transferred to the contact's end station at step 1120. Simultaneously a copy of the text can be displayed in the history section of the user's end station 3.

At step 1130 the contact's end station 3 decrypts the chat text received from the user's end station using the generated encryption key. The decrypted chat text is then displayed in the contact's end station at step 1140 in the history section 40a.

Once this has been completed, the contact can generate a reply at step 1150 by entering text in the current section 40b and selecting the send button 42. The reply will be encrypted using the same encryption key and returned to the user's end station at 1160.

This process can continue as required.

Thus, it will be appreciated that in contrast to the e-mail encryption technique, the user and the contact need only be validated a single time when they first log-on to the system. That validation then remains current as long as the connection between the user's or contact's end station and the base station 1 remains intact. Furthermore, when a user determines who they wish to talk to, the contact automatically receives the user's thumb representation allowing their end station 3 to decrypt any received messages.

The above description is based on the assumption that the user has previously identified the geographical area in which the contact is located, thereby allowing the contact's thumb representation to be determined.

However if this is not be the case, it is necessary for the contact's thumb representation and chat identifier to be located in one of the databases 12. The manner in which this can be achieved can be handled in a number of fashions.

Thus typically the friends list will include information concerning on which base station 1 the contact's user details are provided. This will allow for the automatic location of contact's details from a respective one of the databases 12. This could be achieved automatically by the end station 1, or manually by the user providing an indication after viewing the contact's chat identifier.

Alternatively however, the user could be presented only with details of friends that are currently online and connected to the same base station 1. A further possible manner in which this can be handled for the user to be directed to locate the contact's user details in the manner described before with respect to the e-mail application and FIG. 7.

Thus, the friends list may provide details of users whose details are stored in the database local to the user. If the user wishes to locate contact in a different geographical location, the user will be directed to search the world map, as described above for example with respect to FIG. 12. This allows the user to determine the contact's indicated location, and hence the base station 1 with which the user is associated. The user can then obtain the contact's thumb representation as required.

As outlined briefly above, the present invention can be implemented either as a respective stand alone e-mail application, optionally including software necessary to allow the chat facilities to be provided, or may alternatively be provided as a plug-in for existing mail applications, such as Microsoft Outlook.

In the situation in which the software is applied as a plug-in, this may be achieved, for example, by providing a separate encryption program which is then utilised by Outlook, in a similar fashion to the use of a PGP encryption program and Microsoft Outlook at present.

In any event, whether the software is provided as a plug-in or whether it is provided as a respective application, it will generally also be possible for users to transfer files via the Internet 2 in a secure fashion using the above mentioned techniques. This can be achieved, for example, by using the intended recipient's e-mail address, or other identifier, and then allowing the base station 1 to control the transfer of the file via the Internet 2 to the intended destination.

Alternatively, if the intended recipient's identity is known, this can be used to look up the user data stored in the databases 12. This can then include an identifier that can be used to transfer files directly to the intended recipient. This may be achieved, for example, by the use of the recipients end station IP address, or the like.

In addition to the above, if the user's end station 3 is loaded with e-mail applications software in accordance with the present invention, this would also generally include a number of additional features, as set out below. These additional features operate to provide the user with additional functionality.

The user will normally have an ISP (Internet Service Provider) that is operating as an e-mail server. In this case, the e-mails will be stored on the ISP, allowing the user to view e-mail headers or details (as opposed to content) they have received directly on the ISP without the need to download the content of the entire e-mail to their own end station 3. This then allows the user to delete messages from the server or download the messages as required. It will be appreciated that, the e-mails do not necessarily need to be encrypted.

Furthermore, with the e-mails being temporarily stored on the ISP for subsequent download to the user's end station, this allows the applications software to define extended inbound/outbound filtering rules. This includes the ability to delete e-mails received from specified e-mail addresses as they are received by the ISP, without being transferred to the end station 3. Thereby allowing the user to avoid SPAM e-mail.

This allows various rules to be applied to e-mails both as they are received at the ISP and at the end station 3. This can include facilities such as AutoSave attachments by rule, AutoReply to messages by rule, AutoForward messages by rule, delete messages by rule, and the like. This can therefore be used, for example, to filter out SPAM at the server, as opposed to at the end station 3, thereby reducing the download requirements on both the ISP and the end station 3.

In general, strict anti-viral measures would be implemented within the application on end station 3. This allows users to actively implement a pseudo-firewall on the end station 3, allowing each user to specify types of files which should be checked for viruses, types of files which should be automatically deleted, forwarded to another location or the like.

It will be appreciated that the base station 1 may act as the ISP.

In general, the e-mail applications software operated on the end station 3 will provide other facilities such as the ability to handle HTML e-mail, and the provision of a calendar or agenda system.

The e-mail applications software provided on the end station 3 also supports multiple e-mail account for individuals. This will mean that user data can include multiple e-mail addresses associated with a governed thumb representation per e-mail address. This can allow users to restrict distribution of e-mail addresses, such that only selected individuals know certain e-mail addresses. This can aid in sorting received e-mails.

A further development that can be implemented by the present invention, is for the ability to provide private data object transfer, including chat and e-mail, between secure networks via the Internet 2.

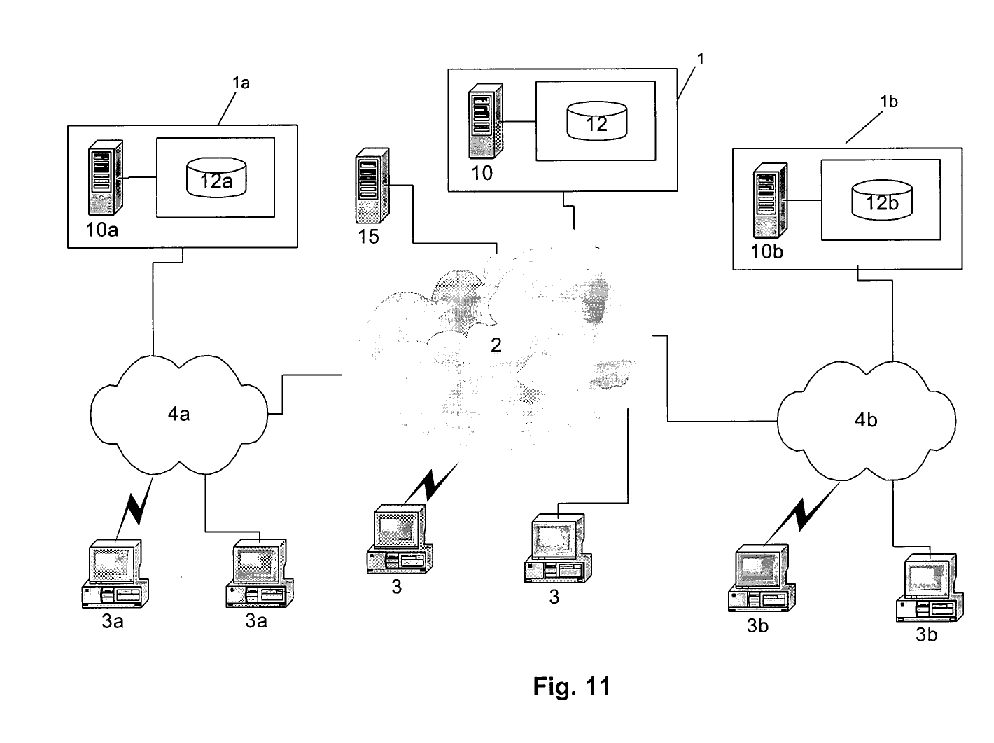

In this case, the transfer may need to be implemented in such a manner that it can be guaranteed that the thumb representations will retain a level of separation from the public. In order to achieve this, the system of the present invention can implement architecture similar to that shown in FIG. 11.

As shown in FIG. 11, each of the LANs 4a, 4b include a respective base station 1a, 1b coupled thereto, to ensure privacy for in-house, corporate or governmental e-mail and data exchange. Each of these base stations 1 generally be inaccessible to any processing systems not located on the respective LAN 4.

Accordingly, this will allow end stations 3a coupled to the LAN 4a to communicate with each other in an encrypted manner. As described above, this may be achieved by e-mail, messaging, or the like.

In this instance, however, as processing systems, including the base station 1, located on the Internet 2, cannot access base station 1a, they are unable to access the thumb representation of any of the users of the end stations 3a. This therefore prevents encrypted transfer between the end stations 3a and the end stations 3 or 3b, which is designed to ensure privacy.

However, as an addition facility, the base stations 1a, 1b could be provided with selected reciprocal access. Accordingly, this will allow the base station 1a, located on the LAN 4a, to obtain limited thumb representations from the base station 4bB, coupled to the LAN 4b. These limited thumb representations may be thumb representations of individual that have been assigned access to transfer encrypted e-mails via the Internet 2.

Thus, for example, if the end stations 4a, 4b are associated with different companies, a member of one company may be authorised to send encrypted e-mails to a member of the other company.

Alternatively, for example, the LANs 4a, 4b may be internal LANs to a Government department, or like, which must retain a minimum level of security. In these circumstances, generally only selected members of the department would be allowed to transfer e-mails via the Internet 2.

In this instance, a user of one of the end stations 3a, is able to browse a list of displayed by the base station 1b showing recipients that can be contacted. This is achieved by having the user generate a request for recipient information, which is transferred to the base station 1a. The base station 1a then contacts the base station 1b transferring the request for information. The base station 1b will access the database 12b and download therefrom a list of individuals with security clearance to transfer encrypted messages via the Internet 2. This information can then be transferred back to the base station 1 a via the Internet 2.

Once the user of the end station 3 has selected a recipient, the recipient's thumb representation is transferred from the base station 1b to the user's end station 1a, via the Internet 2.

It will be appreciated that in this instance, any data, including the thumb representations transferred via the Internet 2 will need to be encrypted. Accordingly, the base stations 1a, 1b will generally need to obtain an encryption key from the key server 15 as shown.

In this case once the user's end station 3 has received the recipient's thumb representation, the end station generates an encryption key. It is then possible to transfer e-mails, chat or transfer data file objects, in the manner described above.

It will be appreciated that the recipient's end station 3b has to determine an encryption key in the manner described above. The user's of the end stations 3a, 3b will also have to undergo validation before sending encrypted data files, in the manner described above with respect to the e-mail procedure.

It will be appreciated that the above descriptions while referring to e-mail and chat as specific examples may equally apply to the transfer of other data objects, such as data files, electronic faxes, digital media, and the like.

Similarly, although the term thumb representation has been used throughout, this would equally apply to fingerprint representations. Additionally, other biometric representation, such as retina prints, facial images, DNA representations, or the like could be used.

However, the use of the thumb or finger representation is particularly beneficial as it is difficult for third parties to construct a fake thumb or finger that would allow an individual to pass themselves off as a user of the system.

Technology in the digit scanning area is generally more advanced than the technology associated with determining other biometric data. As a result, the technology is generally cheaper, more forgiving (for example to incorrect thumb positioning or thumbprint wear), and more reliable. Members of the public are generally more ready to accept the scanning of a thumb or finger, as the use of fingerprints has been around for a number of years. The technology for scanning digits is tried and tested. Furthermore, the technology is now capable of detecting the difference between live and dead digits, thereby prevent someone using a dead persons digit to obtain access to the system

In contrast, facial recognition is generally considered to be more of a psychological deterrent and less practical as it can fooled for example, by the use of make-up rubber moulds or the like.

Voice recognition suffers due to the problems in vocalisation that people have, such as caused by cold or the effects of alcohol.

Finally, whilst retina scanning is generally held to be the most accurate biometric data, the technology required to scan the retina is generally expensive, cumbersome, and difficult to operate. Furthermore, individuals tend to find retina scanning more intrusive than digit scanning, thereby deterring many users from such operations.

Other users of the system include:
Internet Authentication
Desktop Security
Network Security
Financial transaction processing
Medical Records management
Instant Messenger
Document Exchange

Internet authentication generally includes two main types:
Biometric Access Control Authentication for web sites—which uses the consumers biometric such as thumb scan to verify and access a web site.
Biometric Data Encryption and Access Control Authentication for web sites—as with the aforementioned, however with the added benefit of actually encrypting biometrically the actual data transmitted to and from the web page

In general the user's end station processor 20 executes ActiveX components that:
Enable various forms of biometric templates (thumb, voice, face for example) to be scanned from within a web page running on a user's PC, then submitted through the Internet to the web server for verification;
Provide Management and Administration functions through a suit of ASP pages, or the like.

Typically the Suite includes:
An ActiveX control or the like that is implemented into the applicable web page; and,
A series ASP pages that form the Management and Administration components for administering enrolment and access rights.

The ActiveX control is readily integrated into pages on any MS web server. The component can encrypt the template into an input control in a standard online form, to be extracted at the server end and processed.

The supporting component is an ActiveX object instanced on a web server (or a second, possibly dedicated server machine) to process the biometric data, such as thumb representations, communicate either with a private or public server such as the base station 1. Both identify the user and provide the server with necessary user information.

In general the process may be implemented in a manner similar to that described above with respect to the e-mail or chat implementations. In this case, it will be appreciated that the process is often implemented between a user and an entity, such as a web server. Accordingly, an identifier and biometric data or an equivalent may be associated with the entity.

The identifier may be for example an IP address of a web server, or web-site, respective QAN or the like.

Similarly the biometric data may be based on an individual associated with the entity. Alternatively, other equivalent data such as random numbers or the like may be used. Assuming that this equivalent data is unique, this will allow the user to confirm that any data received from the entity is genuinely from the entity. Thus the user can be confident that a web-site is genuine.

The entity's identifier and biometric data can then be used as the contact's chat identifier and thumb representation in the chat process described above to allow a two way transfer of data in a manner similar to transferring chat. Thus, instead of transferring chat, transaction data, medical records, or the like may be transferred, data can be submitted to a web site, or the like.

Thus, when a user wishes to access a web-site, the user will first provide their biometric data to the base station 1, together with an indication of a user's identifier and an entity identifier such as the web-site address. The base station 1, which may in this case be operated entity, uses the user's biometric data and identifier to compare the biometric data to biometric data stored in the database 12, as described in steps 900 to 960. The base station 1 can then determine if the user has authorisation to access the web-site if necessary. This can be achieved by having the base station 1 check access data stored in the database 12, which indicates for a respective web-site the identifiers of users with access permissions.

An indication that access has been granted can then be transferred to the user's end station 3 and optionally to a processing system hosting the web-site, which may be required for example if the web-site is not hosted by the base station 1. Following this, the base station 1 can generate encryption and decryption keys based on the user identifier and biometric data and the web-site or entities equivalent. These are transferred to the user's end station 3 and the processing system hosting the web-site, or the entity, as required. This can be used to encrypt data as it is transferred between the user end station 3 and the entity or web-site as required. It will then be appreciated that by generating appropriate encryption and decryption keys, data may be encrypted either as it is submitted to the entity and/or transferred from the entity to the user. These techniques can also be used to transfer data between entities, as will be appreciated by those skilled in the art.

Thus, these techniques can be used to secure both web sites and transactions for services such as Online Banking, Medical Records, Off-site Corporate Network Access, and Online Shopping to name a few.

To ensure privacy, clients wishing to utilise the system must register for access to different groups of user information. For example, a site using the system simply to verify a user's identity might only be able to access basic user information, but not personal history or financial data.

Multiple levels and methods of encryption are employed to ensure that data transmitted between components in the system is secure from theft or alteration.

The process supports multiple Biometric Signatures such as Thumb, Voice, Iris, face etc. The holistic approach provides for a collaborative and consolidated approach to the authentication process.

The Authentication Suite supports extensive authentication methods and application libraries to ensure security for both the web site being accessed, and for the data being referenced. It allows organisations to deploy any combination of biometric (fingerprint, voice, face, iris and signature) and non-biometric (token and password) user verification technologies and operates seamlessly with all other ThumbAccess Biometrics applications including eMail and chat described above.

The Authentication Suite may also provide the following features and benefits:
Unified authentication management for Network Enterprises and Web-based applications
A flexible policy management system for the implementation of enterprise-wide authentication policies
Centralised and/or distributed administration and authentication management
One-time user enrolment for authentication to multiple applications including;
   Access Control
   eMail
   Payment Systems
   other biometric solutions
Real-time logging of authentication events and detailed reports
A robust security architecture superior to PKI and certainly more efficient to manage.
Hardware independence, allowing different biometrics hardware to be used.

The Authentication Suite's policy system enables an organisation to readily implement varying methods and levels of biometric security throughout the organisation. Policies are defined and managed based on individuals, groups, applications or entry points. When necessary, multi-form-factor authentication such as Thumb and Face can be deployed, facilitating a number of combinations and verification and methods.

Administrative functions in the Authentication Suite are pooled as tasks, which allows them be managed and vetted by an administrator. For example, new user enrolment and access rights can be controlled and managed as can policy management by an administrator from a remote location. Multiple authentication policies configured from a one-time user enrolment can be created and in a matter of moments, administrators can enrol users having established under credentials, and control where that user is able to travel within the web site.

The Authentication Suite provides real-time logging of authentication activity and detailed reports. The reports allow administrators to know who, what, when and where, who is attempting to gain access to what applications; when the attempts occur.

Persons skilled in the art will appreciate that numerous variations and modifications will become apparent. All such variations and modifications which become apparent to persons skilled in the art, should be considered to fall within the spirit and scope that the invention broadly appearing before described.

1. A method of allowing a sender to encrypt a data object for transfer to a recipient via a communication system, the method including:
a. Determining biometric data representative of at least one of the sender and the recipient;
b. Using the determined biometric data to generate an encryption key;
c. Encrypting the data object using the generated encryption key and a predetermined encryption algorithm; and,
d. Transferring the encrypted data object to the recipient via the communications system.

2. A method according to claim 1, the method including generating biometric data by:
a. Generating a scanned image by scanning a portion of the user; and,
b. Generating the biometric data representative of the user from the scanned image.

3. A method according to claim 2, the method of generating the biometric data from the scanned image including applying a predetermined one-way function to the scanned image.

4. A method according to claim 2, the method including generating the encryption key using the generated biometric data representative of the sender.

5. A method according to claim 2, the method further including:
a. Validating the identity of the sender; and,
b. Generating the encryption key in response to a successful validation.

6. A method according to claim 5, the method of validating the sender including:
a. Comparing the generated biometric data representative of the sender to predetermined biometric data representative of the sender; and,
b. Validating the sender in response to a successful comparison.

7. A method according to claim 6, the validation being performed by a processor coupled to a data store, the data store being adapted to store the sender's predetermined biometric data, the processor being adapted to:
a. Receive an indication of the sender;
b. Receive the sender's generated biometric data;
c. Obtain the predetermined biometric data from the data store in accordance with the indication of the sender;
d. Compare the sender's generated biometric data and the predetermined biometric data; and,
e. Validate the sender in response to a successful comparison.

8. A method according to claim 7, the processor and the data store being located at a base station, the method including using an end station to transfer the data object to the recipient via the communications system.

9. A method according to claim 8, the end station including:
a. An input;
b. A scanning system;
c. A communications link, for coupling the end station to the communications system; and,
d. An end station processor, the method including causing the end station processor to:
i. Receive an input command from the sender requesting the transfer of the data object;
ii. Determine sender's biometric data by causing the scanning system to scan a portion of the sender;
iii. Generate the encryption key;
iv. Encrypt the data object with the determined encryption key; and,
v. Transfer the data object to the communications system.

10. A method according to claim 9, the encryption key being generated based on the biometric data of the sender and the recipient.

11. A method according to claim 10, the method further including
a. Causing the end station processor to transfer to the base station:
i. The sender's biometric data;
ii. An indication of the recipient; and,
iii. An indication of the sender;
b. Causing the base station processor to:
i. Validate the sender; and,
ii. In response to a successful validation;
1. Obtain the biometric data of the recipient from a database in accordance with the received indication; and,
2. Transfer the recipient's biometric data to the end station.

12. A method according to claim 11, the method including causing the end station processor to transfer the sender's biometric data to the base station by:
a. Encrypting the sender's biometric data; and,
b. Transferring the sender's encrypted biometric data to the base station, the base station processor being adapted to decrypt the received encrypted biometric data.

13. A method according to claim 12, the biometric data being encrypted using a second predetermined encryption algorithm and a second encryption key, the second encryption key being generated by a remote processing system, the method including:
a. Causing the end station processor to:
i. Obtain the second encryption key from the remote processing system; and,
ii. Encrypt the sender's biometric data using the second encryption algorithm and the obtained second encryption key;
b. Causing the base station processor to decrypt the encrypted sender's biometric data by:
i. Obtaining the second encryption key from the remote processing system; and,
ii. Decrypting the sender's encrypted biometric data using the second encryption algorithm and the obtained second encryption key.

14. A method according to claim 15, the method of obtaining the second encryption key from the remote processing system and including the steps of:
a. Generating a request for an encryption key;
b. Transferring the request to the remote processing system;
c. Causing the remote processing system to:
i. Generate the second key;
ii. Encrypt the second encryption key;
iii. Transfer the encrypted second encryption key via a secure connection;
d. Receiving the encrypted second encryption key via the secure connection; and,
e. Decrypt the second encryption key.

15. A method according to any of claim 11, the method including causing the base station processor to transfer the recipient's biometric data to the base station by:
a. Encrypting the recipient's biometric data; and,
b. Transferring the recipient's encrypted biometric data to the end station, the end station processor being adapted to decrypt the received encrypted biometric data.

16. A method according to claim 15, the biometric data being encrypted using a third predetermined encryption algorithm and a third encryption key, the third encryption key being generated by a remote processing system, the method including:
a. Causing the base station processor to:
i. Obtain the third encryption key from the remote processing system; and,
ii. Encrypt the recipient's biometric data using the third encryption algorithm and the obtained third encryption key;
b. Causing the end station processor to decrypt the encrypted biometric data by:
i. Obtaining the third encryption key from the remote processing system; and,
ii. Decrypting the recipient's encrypted biometric data using the third encryption algorithm and the obtained third encryption key.

17. A method according to claim 16, the method of obtaining the third encryption key from the remote processing system including:
a. Generating a request for an encryption key;
b. Transferring the request to the remote processing system;
c. Causing the remote processing system to:
i. Generate the third key;
ii. Encrypt the third encryption key;
iii. Transfer the encrypted third encryption key via a secure connection;
d. Receiving the encrypted third encryption key via the secure connection; and,
e. Decrypt the third encryption key.

18. A method according to claim 14, the secure connection being a 128-bit SSL connection.

19. A method according to claim 1, the data object including an e-mail.

20. A method according to claim 19, the e-mail including an attachment.

21. A method according to claim 19, the indication being an e-mail address.

22. A method according to claim 1, the biometric data being formed from by scanning the user's thumb.

23. An end station for allowing a sender to encrypt a data object for transfer to a recipient via a communication system, the end station including:
a. An input;
b. A communications link, for coupling the end station to the communications system; and,
c. An end station processor, adapted to:
i. Receive an input command from the sender requesting the transfer of the data object;
ii. Determine an encryption key based on biometric data representative of at least one of the sender and the recipient;
iii. Encrypt the data object with the encryption key; and,
iv. Transfer the data object to the communications system.

24. An end station according to claim 23, the end station the end station further including a scanning system, the scanning system being adapted to determine the sender's biometric data by scanning a portion of the sender.

25. The method of claim 1 performed with an end station for allowing a sender to encrypt a data object for transfer to a recipient via a communication system, the end station including:
a. An input;
b. A communications link, for coupling the end station to the communications system; and,
c. An end station processor, adapted to:
i. Receive an input command from the sender requesting the transfer of the data object;
ii. Determine an encryption key based on biometric data representative of at least one of the sender and the recipient;
iii. Encrypt the data object with the encryption key; and,
iv. Transfer the data object to the communications system.

26. A base station for allowing a sender to encrypt a data object for transfer to a recipient via a communication system, the base station including:
a. A data store for storing biometric data;
b. A processor, the processor being adapted to validate the sender to allow the data object to be encrypted by:
i. Receiving an indication of the sender;
ii. Receiving the sender's generated biometric data;
iii. Obtaining predetermined biometric data from the data store in accordance with the indication of the sender;
iv. Comparing the sender's generated biometric data and the predetermined biometric data; and,
v. Validating the sender in response to a successful comparison.

27. The method of claim 1 performed with a base station for allowing a sender to encrypt a data object for transfer to a recipient via a communication system, the base station including:
a. A data store for storing biometric data;
b. A processor, the processor being adapted to validate the sender to allow the data object to be encrypted by:
i. Receiving an indication of the sender;
ii. Receiving the sender's generated biometric data;
iii. Obtaining predetermined biometric data from the data store in accordance with the indication of the sender;
iv. Comparing the sender's generated biometric data and the predetermined biometric data; and,
v. Validating the sender in response to a successful comparison.

28. Apparatus for allowing a sender to encrypt a data object for transfer to a recipient via a communication system, the apparatus including a processor adapted to:
a. Determine biometric data representative of at least one of the sender and the recipient;
b. Use the determined biometric data to generate an encryption key;
c. Encrypt the data object using the generated encryption key and a predetermined encryption algorithm; and,
d. Transfer the encrypted data object to the recipient via the communications system.

29. The method of claim 1 performed with apparatus for allowing a sender to encrypt a data object for transfer to a recipient via a communication system, the apparatus including a processor adapted to:
a. Determine biometric data representative of at least one of the sender and the recipient;
b. Use the determined biometric data to generate an encryption key;
c. Encrypt the data object using the generated encryption key and a predetermined encryption algorithm; and,
d. Transfer the encrypted data object to the recipient via the communications system.

30. A method of allowing a recipient to decrypt an encrypted data object received from a sender via a communication system, the method including:
a. Receiving the encrypted data object from the communications system;
b. Determining biometric data representative of at least one of the sender and the recipient;
c. Using the determined biometric data to generate a decryption key; and,
d. Decrypting the encrypted data object using the generated decryption key and a predetermined decryption algorithm.

31. A method according to claim 30, the method including generating biometric data by:
a. Generating a scanned image by scanning a portion of the user; and,
b. Generating the biometric data representative of the user from the scanned image.

32. A method according to claim 31, the method of generating the biometric data from the scanned image including applying a predetermined one-way function to the scanned image.

33. A method according to claim 31, the method including generating the decryption key using the generated biometric data representative of the recipient.

34. A method according to claim 31, the method further including:
a. Validating the identity of the recipient; and,
b. Generating the decryption key in response to a successful validation.

35. A method according to claim 34, the method of validating the recipient including:
a. Comparing the generated biometric data representative of the recipient to predetermined biometric data representative of the recipient; and,
b. Validating the recipient in response to a successful comparison.

36. A method according to claim 35, the validation being performed by a processor coupled to a data store, the data store being adapted to store the recipient's predetermined biometric data, the processor being adapted to:
a. Receive an indication of the recipient;
b. Receive the recipient's generated biometric data;
c. Obtain the predetermined biometric data from the data store in accordance with the indication of the recipient;
d. Compare the recipient's generated biometric data and the predetermined biometric data; and,
e. Validate the recipient in response to a successful comparison.

37. A method according to claim 36, the processor and the data store being located at a base station, the method including using an end station to decrypt the encrypted data object received via the communications system.

38. A method according to claim 37, the end station including:
a. An input;
b. A scanning system;
c. A communications link, for coupling the end station to the communications system; and,
d. An end station processor, the method including causing the end station processor to:
i. Receive an input command from the recipient requesting the decryption of the data object;
ii. Determine recipient's biometric data by causing the scanning system to scan a portion of the recipient;
iii. Generate the decryption key; and,
iv. Decrypt the data object with the determined decryption key.

39. A method according to claim 39, the encryption key being generated based on the biometric data of the sender and the recipient.

40. A method according to claim 39, the method further including
a. Causing the end station processor to transfer to the base station:
i. The recipient's biometric data;
ii. An indication of the sender; and,
iii. An indication of the recipient;
b. Causing the base station processor to:
i. Validate the recipient; and,
ii. In response to a successful validation:
1. Obtain the biometric data of the sender from a database in accordance with the received indication; and,
2. Transfer the sender's biometric data to the end station.

41. A method according to claim 39, the method including causing the end station processor to transfer to the recipient's biometric data to the base station by:
a. Encrypting the recipient's biometric data; and,
b. Transferring the recipient's encrypted biometric data to the base station, the base station processor being adapted to decrypt the received encrypted biometric data.

42. A method according to any of claim 39, the biometric data being encrypted using a second predetermined encryption algorithm and a second encryption key, the second encryption key being generated by a remote processing system, the method including:
a. Causing the end station processor to:
i. Obtain the second encryption key from the remote processing system; and,
ii. Decrypt the recipient's biometric data using the second encryption algorithm and the obtained second encryption key;
b. Causing the base station processor to decrypt the decrypted recipient's biometric data by:
i. Obtaining the second encryption key from the remote processing system; and,
ii. Decrypting the recipient's encrypted biometric data using the second encryption algorithm and the obtained second encryption key.

43. A method according to claim 39, the method including causing the base station processor to transfer the sender's biometric data to the base station by:
a. Encrypting the biometric data; and,
b. Transferring the encrypted biometric data to the end station, the end station processor being adapted to decrypt the received encrypted biometric data.

44. A method according to claim 40, the biometric data being encrypted using a third predetermined encryption algorithm and a third encryption key, the third encryption key being generated by a remote processing system, the method including:
a. Causing the base station processor to:
i. Obtain the third encryption key from the remote processing system; and,
ii. Encrypt the biometric data using the third decryption algorithm and the obtained third encryption key;
b. Causing the end station processor to decrypt the encrypted biometric data by:
i. Obtaining the third encryption key from the remote processing system; and,
ii. Decrypting the encrypted biometric data using the third encryption algorithm and the obtained third encryption key.

45. A method according to claim 30, the data object including an e-mail.

46. A method according to claim 45, the e-mail including an attachment.

47. A method according to claim 45, when dependent on claim 38 or claim 42, the indication being an e-mail address.

48. A method according to claim 30, the biometric data being formed by scanning the user's thumb.

49. An end station for allowing a recipient to decrypt an encrypted data object received from a sender via a communication system, the end station including:
a. An input;
b. A communications link, for coupling the end station to the communications system; and,
c. An end station processor, adapted to:
i. Receive an input command from the recipient requesting the decryption of the encrypted data object;
ii. Determine an decryption key based on biometric data representative of at least one of the recipient and the sender; and,
iii. Decrypt the data object with the decryption key.

50. An end station according to claim 49, the end station the further including a scanning system, the scanning system being adapted to determine the recipient's biometric data by scanning a portion of the recipient.

51. The method of claim 30 performed with an end station for allowing a recipient to decrypt an encrypted data object received from a sender via a communication system, the end station including:
a. An input;
b. A communications link, for coupling the end station to the communications system; and,
c. An end station processor, adapted to:
i. Receive an input command from the recipient requesting the decryption of the encrypted data object;
ii. Determine an decryption key based on biometric data representative of at least one of the recipient and the sender; and,
iii. Decrypt the data object with the decryption key.

52. A base station for allowing a recipient to decrypt an encrypted data object received from a sender via a communication system, the base station including:
a. A data store for storing biometric data;
b. A processor, the processor being adapted to validate the recipient to allow the data object to be decrypted by:
i. Receiving an indication of the recipient;
ii. Receiving the recipient's generated biometric data;
iii. Obtaining predetermined biometric data from the data store n accordance with the indication of the sender;
iv. Comparing the recipient's generated biometric data and the predetermined biometric data; and,
v. Validating the recipient in response to a successful comparison.

53. Apparatus for allowing a recipient to decrypt an encrypted data object received from a sender via a communication system, the apparatus including a processor adapted to:
a. Determine biometric data representative of at least one of the recipient and the sender;
b. Use the determined biometric data to generate a decryption key;
c. Decrypt the data object using the generated decryption key and a predetermined decryption algorithm; and,
d. Transfer the decrypted data object to the sender via the communications system.

54. The method of claim 30 performed with an apparatus for allowing a recipient to decrypt an encrypted data object received from a sender via a communication system, the apparatus including a processor adapted to:
a. Determine biometric data representative of at least one of the recipient and the sender;
b. Use the determined biometric data to generate a decryption key;
c. Decrypt the data object using the generated decryption key and a predetermined decryption algorithm; and,
d. Transfer the decrypted data object to the sender via the communications system.
